(19) United States
(12) Patent Application Publication
(10) Pub. No.: US 2020/0313157 A1
(43) Pub. Date: Oct. 1, 2020

(54) OVER-LITHIATED CATHODES FOR LITHIUM ION BATTERIES AND PROCESSES OF MANUFACTURE

(71) Applicant: UChicago Argonne, LLC, Chicago, IL (US)

(72) Inventors: Christopher S. Johnson, Naperville, IL (US); Wesley Dose, Hinsdale, IL (US); Premkumas Senguttuvan, Bangalore (IN)

(21) Appl. No.: 16/752,000

(22) Filed: Jan. 24, 2020

Related U.S. Application Data
(60) Provisional application No. 62/825,277, filed on Mar. 28, 2019.

(51) Int. Cl. H01M 4/04; H01M 4/505; H01M 4/525

(52) U.S. Cl. CPC H01M 4/0445; H01M 2004/028; H01M 4/525; H01M 4/505

(57) ABSTRACT

A process for preparing electrochemically or chemically over-lithiated cathodic active materials includes contacting lithium-ammonia or lithium naphthalenide with a lithium metal oxide cathode active material to form the chemically over-lithiated cathode active material.

### CROSS-REFERENCE TO RELATED APPLICATIONS

This application claims the benefit of and priority to U.S. Patent Application No. 62/825,277, filed on Mar. 28, 2019, and which is incorporated herein by reference in its entirety for any and all purposes.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD OF INVENTION

The present technology relates generally to lithium rechargeable batteries. More particularly, the present technology relates to chemically and/or electrochemically over-lithiated cathode active materials for lithium ion batteries, and methods for making the chemically and/or electrochemically over-lithiated cathode active materials.

### BACKGROUND

The following description of the background of the present technology is provided simply as an aid in understanding the present technology and is not admitted to describe or constitute prior art to the present technology.

Lithium-ion batteries are classes of electrochemical energy storage devices that comprise a cathode (positive electrode), an anode (negative electrode), and an electrolyte filling the space between the electrically insulated cathode and anode. In general, a porous separator is used to electrically separate the cathode from the anode. The electrolyte typically comprises a lithium salt dissolved in a non-aqueous (aprotic) organic solvent, which may be a linear carbonates, such as ethylmethylcarbonate, or a cyclic carbonate, like ethylene carbonate.

Lithium-ion batteries are ubiquitously used in vast energy storage applications ranging from consumer portable devices, to electric vehicles, and grid storage. In traditional lithium-ion batteries, graphitic materials are the dominant negative electrode materials as the intercalation host for lithium ions. Typically, this class of materials can deliver a theoretical specific capacity of about 372 mAh/g, however this energy density is too low for future energy intensive applications. To boost the energy density, Si and other Si-based alloys with Sn, and/or oxide derivatives such as SiO₂ are emerging as alternative high capacity anodes for Li-ion batteries. The Si electrode can be electrochemically lithiated to a stoichiometry of Li₂₂Si₅, which equates to about 3700 mAh/g, roughly 10 times that of a graphite anode. However, the disadvantages for these types of materials is the high volumetric changes that can occur upon cycling (up to 300%). This dramatic volumetric change of the Li_{y}Si particles challenges the mechanical integrity of the electrode, and ultimately causes cracking and failure of the electrode. Si electrodes are therefore typically made as composites with graphite or other carbonaceous electrodes that can alleviate or buffer the high stress in the electrodes and maintain the mechanical integrity.

In addition to the aforementioned problems, the >300% volume expansion creates new active surfaces on the electrode particles during (de)lithiation. This deleterious process leads to repeated solid electrolyte interphase (SEI) growth and irreversible trapping of cyclable Li in the full cell, which negatively impacts performance, and lowers cyclable life. Solid electrolyte interphase formation is difficult to control, and, as such electrolyte additives such as fluoroethylene carbonate (FEC) is used to stabilize the SEI to further limit Li trapping. However, this method only is a stopgap measure, and the effectiveness is lost with cycling. Moreover, electrode voltage slippage occurs whereby the lithium inventory in the battery is compromised, and less cathode material can be utilized. Such problems cause active material cathode overcharging and battery performance decline.

It is therefore of great interest to the battery industry to processes to increase the amount of cyclable lithium ion in an electrochemical cell, thereby overcoming the drawbacks of traditional lithium ion batteries for energy intensive applications.

### SUMMARY

In one aspect, the present disclosure provides for a process for preparing a chemically over-lithiated cathode active material, wherein the process includes contacting lithium-ammonia or lithium naphthalenide with a lithium metal oxide cathode active material to form the chemically over-lithiated cathode active material. In some embodiments, the chemically over-lithiated cathode active material includes a first lithium metal oxide phase and a second lithium metal oxide phase that is different from the first lithium metal oxide phase.

In some embodiments, the process includes contacting the lithium-ammonia with the lithium metal oxide cathode active material.

In some embodiments, the process includes contacting the lithium naphthalenide with the lithium metal oxide cathode active material. In some embodiments, the over-lithiated cathode material may be prepared at about room temperature.

In some embodiments, the lithium metal oxide cathode active material includes a compound of formula Li_{δ}(M¹_{y}Mn_{2-y})Oₚ, Li_{δ(M}²_{y})Oₚ, Li_{δ(}M²_{y}M³_{2-y})Oₚ, or Li_{δ}(M¹_{y′}R¹ₐ)O_{p′}; wherein M¹ is Cr, Fe, Co, Ni, Cu, or a mixture of any two or more thereof; M² is Fe, Co, Ni, Mn, Ti, V, or a mixture of any two or more thereof; M³ is different from M² and is Fe, Co, Ni, Mn, Ti, V, or a mixture of any two or more thereof; R¹ is O, OH, F, Cl, Br, S or I; wherein 0<y<2; 1≤y′≤3; 0<p≤4; 0<p′≤8; 0≤δ≤2; and 0≤a≤1.

In some embodiments, the lithium metal oxide cathode active material includes LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof. In some embodiments, the lithium metal oxide cathode active material comprises LiMn₂O₄, LiNi_{0.5}Mn_{1.5}O₄, or LiNi_{0.5}Mn_{0.3}Co_{0.2}O₄.

In some embodiments, the first lithium metal oxide phase includes LiNi_{m′}Mn_{n′}Co_{o′}O_{p′}; and wherein 0≤m′<1; 0≤n′<1; 0≤o′<1; 0.5≤p′≤4; and where m′+n′+o′=1. In some embodiments, the first lithium metal oxide phase comprises LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In another aspect, the present disclosure provides for the chemically over-lithiated metal oxide cathode active material prepared by the process of any embodiment disclosed herein.

In one aspect, the present disclosure provides for a process for preparing an electrochemically over-lithiated cathode active material, wherein the process includes cycling a half cell comprising a lithium metal oxide cathode active material and a lithium metal counter electrode to form the chemically over-lithiated cathode active material. In some embodiments, the electrochemically over-lithiated cathode active material includes a first lithium metal oxide phase and a second lithium metal oxide phase that is different from the first lithium metal oxide phase.

In some embodiments, the lithium metal oxide cathode active material includes a compound of formula Li_{δ}(M¹_{y}Mn_{2-y})Oₚ, Li_{δ}(M²_{y})Oₚ, Li_{δ}(M²_{y}M³_{2-y})Oₚ, or Li_{δ}(M¹_{y′}R¹ₐ)O_{p′}; wherein M¹ is Cr, Fe, Co, Ni, Cu, or a mixture of any two or more thereof; M² is Fe, Co, Ni, Mn, Ti, V, or a mixture of any two or more thereof; M³ is different from M² and is Fe, Co, Ni, Mn, Ti, V, or a mixture of any two or more thereof; R¹ is O, OH, F, Cl, Br, S or I; wherein 0<y<2; 1≤y′≤3; 0<p≤4; 0<p′≤8; 0≤δ≤2; and 0≤a≤1.

In some embodiments, the lithium metal oxide cathode active material includes LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof. In some embodiments, the lithium metal oxide cathode active material comprises LiMn₂O₄, LiNi_{0.5}Mn_{1.5}O₄, or LiNi_{0.5}Mn_{0.3}Co_{0.2}O₄.

In some embodiments, the first lithium metal oxide phase includes LiNi_{m′}Mn_{n′}Co_{o′}O_{p′}; and wherein: 0≤m′<1; 0≤n′<1; 0≤o′<1; 0.5≤p′≤4; and where m′+n′+o′=1. In some embodiments, the first lithium metal oxide phase includes LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein: 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In another aspect, the present disclosure provides for the electrochemically over-lithiated metal oxide cathode active material prepared by the process of any embodiment disclosed herein.

In another aspect, the present disclosure provides for a chemically over-lithiated cathode active material that includes a first lithium metal oxide phase of formula LiMetOₚ, and a second lithium metal oxide phase of formula Li_{δ}MetOₚ; wherein Met is a transition metal or a mixture of transition metals; 1<δ≤2; and 0.5≤p≤8.

In some embodiments, Met includes one or more of Al, B, Co, Cr, Cu, Fe, Ga, Mg, Mn, Ni, Si, Ti, V, Zn, Zr, or a mixture of any two or more thereof. In some embodiments, Met may be a mixture of Co, Mn, and Ni.

In some embodiments, the first lithium metal oxide phase includes LiNi_{m′}Mn_{n′}Co_{o′}O_{p′}; and wherein: 0≤m′<1; 0≤n′<1; 0≤o′<1; 0.5≤p′≤4; and where m′+n′+o′=1. In some embodiments, the first lithium metal oxide phase includes LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein: 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In some embodiments, the first lithium metal oxide phase may have a substantially spinel structure. In some embodiments, the second lithium metal oxide phase may have a substantially layered structure.

In another aspect, the present disclosure provides for an electrochemically over-lithiated cathode active material that includes a first lithium metal oxide phase of formula LiMetOₚ, and a second lithium metal oxide phase of formula Li_{δ}MetOₚ; wherein Met is a transition metal or a mixture of transition metals; 1<δ≤2; and 0.5≤p≤8.

In some embodiments, Met includes one or more of Al, B, Co, Cr, Cu, Fe, Ga, Mg, Mn, Ni, Si, Ti, V, Zn, Zr, or a mixture of any two or more thereof. In some embodiments, Met may be a mixture of Co, Mn, and Ni.

In some embodiments, the first lithium metal oxide phase includes LiNi_{m′}Mn_{n′}Co_{o′}O_{p′}; and wherein: 0≤m′<1; 0≤n′<1; 0≤o′<1; 0.5≤p′≤4; and where m′+n′+o′=1. In some embodiments, the first lithium metal oxide phase includes LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein: 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In some embodiments, the first lithium metal oxide phase may have a substantially spinel structure. In some embodiments, the second lithium metal oxide phase may have a substantially layered structure.

In another aspect, the present disclosure provides for a lithium ion battery that includes a non-aqueous electrolyte, an anode, and a cathode that includes a chemically over-lithiated cathode active material that includes a first lithium metal oxide phase of formula LiMetOₚ, and a second lithium metal oxide phase of formula Li_{δ}MetOₚ; wherein Met is a transition metal or a mixture of transition metals; 1<δ≤2; and 0.5≤p≤8.

In some embodiments, the cathode, anode, or both the cathode and anode further include a current collector. In some embodiments, the current collector includes copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

In another aspect, the present disclosure provides for a lithium ion battery that includes a non-aqueous electrolyte, an anode, and a cathode that includes an electrochemically over-lithiated cathode active material that includes a first lithium metal oxide phase of formula LiMetOₚ, and a second lithium metal oxide phase of formula Li_{δ}MetOₚ; wherein Met is a transition metal or a mixture of transition metals; 1<δ≤2; and 0.5≤p≤8.

In some embodiments, the cathode, anode, or both the cathode and anode further include a current collector. In some embodiments, the current collector includes copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

### BRIEF DESCRIPTION OF THE DRAWINGS

FIG. 1 illustrates normalized high-resolution synchrotron X-ray diffraction patterns of LiNi_{0.5}Mn_{1.5}O₄ and chemically over-lithiated Li₁₊ₓNi_{0.5}Mn_{1.5}O₄ (wavelength 0.412664 Å), according to the examples. The gray dashed lines denote the location of diffraction peaks of over-lithiated Li₂Ni_{0.5}Mn_{1.5}O₄.

FIG. 2 illustrates normalized high-resolution synchrotron X-ray diffraction patterns of LiNi_{0.5}Mn_{1.5}O₄ and ammonia-treated Li_{1.04}Ni_{0.5}Mn_{1.5}O₄, i.e., without addition of lithium metal (wavelength 0.412664 Å), according to the examples. The gray dashed lines indicate no changes to the cubic LiNi_{0.5}Mn_{1.5}O₄ diffraction peaks.

FIGS. 3A-3G illustrate the Rietveld refined fit of high-resolution synchrotron X-ray diffraction data of Li₁₊ₓNi_{0.5}Mn_{1.5}O₄ (wavelength 0.412664 Å), according to the examples. Data is shown as black crosses, the fit as a red line and the difference between the data and the fit as a green line below the data. Insets in (FIG. 3(A)) and (FIG. 3(G)) highlight the 111 reflection from the cubic Li₁Ni_{0.5}Mn_{1.5}O₄ phase (5.01° 2θ) and the 101 reflection from the tetragonal Li₂Ni_{0.5}Mn_{1.5}O₄ phase (4.94° 2θ), and the quality of the fit in the 4.8<2θ<5.2 region. Average Rwp=16.07% and goodness of fit=3.04.

FIG. 4 illustrates normalized high-resolution synchrotron X-ray diffraction patterns of Li_{1.75}Ni_{0.5}Mn_{1.5}O₄ before and after washing with anhydrous methanol (wavelength 0.414534 Å), according to the examples. The inset displays the unwashed sample in the region 7.5-10.5° 2θ, highlighting the presence of a LiOH impurity (denoted by asterisks, 220 diffraction peak at 8.9° 2θ being the most prominent). The gray dashed lines indicate the location of diffraction peaks of over-lithiated Li₂Ni_{0.5}Mn_{1.5}O₄.

FIGS. 5A-5B illustrate potential profiles for the first (FIG. 5(A)) and the second (FIG. 5(B)) charge and discharge of LiNi_{0.5}Mn_{1.5}O₄ and chemically over-lithiated Li₁₊ₓNi_{0.5}Mn_{1.5}O₄ versus lithium metal at a rate of C/10, according to the examples.

FIG. 6 illustrates the discharge capacity over 40 cycles for LiNi_{0.5}Mn_{1.5}O₄ and chemically over-lithiated Li₁₊ₓNi_{0.5}Mn_{1.5}O₄ versus lithium metal at a rate of C/10, according to the examples.

FIGS. 7A-7D illustrate scanning electron microscopy images of (FIGS. 7(A) and 7(B)) LiNi_{0.5}Mn_{1.5}O₄ and (FIGS. 7(C) and 7(D)) chemically lithiated Li_{1.96}Ni_{0.5}Mn_{1.5}O₄ at magnification ×5000 (left panels) and ×10000 (right panels), according to the examples. Orange arrows highlight the particle cracking present in high lithium content Li₁₊ₓNi_{0.5}Mn_{1.5}O₄.

FIGS. 8A-8B illustrate potential profiles for the first cycle of (FIG. 8(A)) graphite and (FIG. 8(B)) Si-graphite versus lithium metal at a rate of C/10 highlighting the irreversible capacity in mAh g⁻¹ of active material, according to the examples.

FIGS. 9A-9B illustrate full cell potential profiles for the (FIG. 9(A)) first and (FIG. 9(B)) second charge and discharge of LiNi_{0.5}Mn_{1.5}O₄ and chemically lithiated Li_{1.35}Ni_{0.5}Mn_{1.5}O₄ versus a graphite anode at a rate of C/10, according to the examples.

FIGS. 10A-10B illustrate full cell (FIG. 10(A)) discharge capacity and (FIG. 10(B)) cycle efficiency over 100 cycles for LiNi_{0.5}Mn_{1.5}O₄ and chemically lithiated Li_{1.35}Ni_{0.5}Mn_{1.5}O₄ versus graphite at a rate of C/10, according to the examples. Filled data symbols represent the average of two duplicate cells, with error bars showing the deviation between them. The open data symbols in (FIG. 10(B)) represent the region where a scheduled ˜20 h power shutdown interrupted cycling and the subsequent cell recovery/break-in time (cycles 47-58 or 47-61). In this region data is shown from the two cells separately since they were interrupted on different cycle numbers.

FIGS. 11A-11B illustrate full cell potential profiles for the first (FIG. 11(A)) and second (FIG. 11(B)) charge and discharge of LiNi_{0.5}Mn_{1.5}O₄ and chemically lithiated Li_{1.62}Ni_{0.5}Mn_{1.5}O₄ versus a Si-graphite composite anode at a rate of C/10, according to the examples.

FIGS. 12A-12B illustrate full cell discharge capacity (FIG. 12(A)) and cycle efficiency (FIG. 12(B)) over 100 cycles for LiNi_{0.5}Mn_{1.5}O₄ and chemically lithiated Li_{1.62}Ni_{0.5}Mn_{1.5}O₄ versus Si-graphite at a rate of C/10, according to the examples. Filled data symbols represent the average of two duplicate cells, with error bars showing the deviation between them. The open data symbols in (FIG. 12(B)) represent the region where a scheduled ˜20 h power shutdown interrupted cycling of LiNi_{0.5}Mn_{1.5}O₄ and the subsequent cell recovery/break-in time (cycles 95-100). In this region data is shown from the two cells separately since they were interrupted on different cycle numbers.

FIGS. 13A-13B illustrate the over-lithiation capability of a layered LiNi_{0.5}Co_{0.2}Mn_{0.3}O₂ cathode. FIG. 13(A) illustrates potential profiles for LiNi_{0.5}Co_{0.2}Mn_{0.3}O₂ for galvanostatic lithiation (red) compared to the standard delithiation-lithiation (black) versus lithium metal at a rate of C/10, according to the examples. In FIG. 13(B)) the potential relaxation after 20 mAh g⁻¹_{NCM} over-lithiation is illustrated.

FIG. 14 illustrates the over-lithiation capability of a layered LiNi_{0.5}Co_{0.2}Mn_{0.3}O₂ cathode after a charge-discharge cycle versus lithium metal at a rate of C/10, according to the examples.

FIG. 15(A) illustrates potential profiles for LiNi_{0.5}Co_{0.2}Mn_{0.3}O₂ during over-lithiation to various extents (inset) and the following cycle between 4.5 and 3.0 V. FIG. 15(B) illustrates discharge capacity over 50 cycles for LiNi_{0.5}Co_{0.2}Mn_{0.3}O₂ without over-lithiation (black data) and with over-lithiation to various extents (colored data), according to the examples. FIG. 15(C) illustrates lithium content (z in Li_{z}Ni_{0.5}Co_{0.2}Mn_{0.3}O₂) in the first charged state, and FIG. 15(D) illustrates cycle efficiency as a function of over-lithiation capacity, according to the examples. In FIG. 15(D) the cycle number is indicated. The closed and open black data points show the measured and corrected first cycle efficiency, respectively. The corrected efficiency is calculated using efficiency_{corrected}=Q_{d}/(Q_{c}−Qₒ), where Q is the capacity, and d, c, and o represent discharge, charge and over-lithiation, respectively.

FIGS. 16A-16F illustrate the transition metal oxidation state and local structure change after over-lithiation, according to the examples. FIG. 16(A)-16(C) illustrate X-ray absorption near edge structure (XANES) spectra for the pristine and over-lithiated Li₁₊ₓNi_{0.5}Co_{0.2}Mn_{0.3}O₂ at the Mn, Co and Ni K-edge. FIGS. 16(D)-16(F) illustrate extended X-ray absorption fine structure (EXAFS) spectra for the pristine and over-lithiated Li₁₊ₓNi_{0.5}Co_{0.2}Mn_{0.3}O₂ at the Mn, Co and Ni K-edge.

FIGS. 17A-17B illustrate the evolution of selected peaks from in situ X-ray diffraction data together with the potential profiles for the over-lithiation and subsequent charge-discharge cycle of LiNi_{0.5}Co_{0.2}Mn_{0.3}O₂, according to the examples. Over-lithiation step to a 20 mAh g⁻¹ limit (FIG. 17(A)), and 1.1 V limit (112 mAh g⁻¹, FIG. 17(B)) are shown. The plot to the left of (FIG. 17(B)) shows the zoomed region indicated by a rectangle, and tracks the position of the weak 001 reflection from the Li₂NCMO₂ phase.

FIG. 18 illustrates the expansion of the c-axis in the layered structure for the over-lithiated phase Li₁₊ₓNi_{0.5}Co_{0.2}Mn_{0.3}O₂ material. The interlayer spacing is expanded in the over-lithiated material in two aspects. One is a solid-solution region 1 by around 0.018 Å and the second with a unique d-spacing of 2.51 to 2.70 Å.

FIGS. 19A-19C illustrate potential profiles (FIG. 19(A)) and a and c lattice parameters (FIGS. 19(B) and 19(C), respectively) obtained from Rietveld refinements during over-lithiation (O), delithiation (D) and relithiation (R), according to the examples. The estimated errors are within the data markers. A solid line is shown over the relithiation data showing the pathway without structural hysteresis, labelled the line of reversibility (LOR).

FIGS. 20A-20H illustrate potential profiles (FIG. 20(A)) and a and c lattice parameters (FIGS. 20(B) and 20(C), respectively) obtained from Rietveld refinements during over-lithiation (O) to 20 and 100 mAh g⁻¹_{NCM}, and subsequent delithiation (D) and relithiation (R), according to the examples. The estimated errors are within the data markers. A solid line is shown over the relithiation data showing the pathway without structural hysteresis, labelled the line of reversibility (LOR). Critical lattice parameter differences are highlighted in FIGS. 20(D)-20(H); upon return to x=1 (FIGS. 20(D) and 20(E)), towards the end of delithiation (FIG. 20(F)), and in the early stages of relithiation (FIGS. 20(G)-20(H)).

FIG. 21 illustrates a representative potential profile for a Si-graphite electrode in the first cycle between 50 mV and 1.5 V versus lithium metal, according to the examples.

FIG. 22 illustrates the potential profile of a LiNi_{0.5}Co_{0.2}Mn_{0.3}O₂/Si-graphite full cell, according to the examples. The additional capacity required to refill all available lithium sites of the cathode (taking into account the Coulombic efficiency of LiNi_{0.5}Co_{0.2}Mn_{0.3}O₂ as measured in a half cell) is shown.

FIGS. 23A-23B illustrate specific discharge (FIG. 23(A)) and Coulombic efficiencies (FIG. 23(B)) of Li₁₊ₓNi_{0.5}Co_{0.2}Mn_{0.3}O₂/Si-graphite cells with varying degrees of electrochemical over-lithiation during cycling between 3.0-4.5 V and at 30° C., according to the examples. The first and last three cycles of each set of 100 cycles were performed at C/20, cycle 4 and 97 are HPPC cycles, and cycles 5-95 were performed at C/3. Capacity retention at cycle 100 and 200 (compared to cycle 2) are indicated. Results are averaged over two cells and the error bars (in many cases smaller than the symbols) represent the variation between the cells.

FIG. 24 illustrates area specific impedance (ASI) data as a function of the full cell voltage from HPPC cycles, according to the examples. Results are averaged over two cells and the error bars (in many cases smaller than the symbols) represent the variation between the cells.

FIG. 25 illustrates the X-ray diffraction pattern of a chemically over-lithiated Li₁₊ₓNi_{0.5}Co_{0.2}Mn_{0.3}O₂ (labeled as Li₂NCMO₂), and normal layered LiN_{0.5}Co_{0.2}Mn_{0.3}O₂ (labeled as Li₁NCMO₂). The over-lithiated Li₁₊ₓNi_{0.5}Co_{0.2}Mn_{0.3}O₂ was prepared via chemical lithiation at room temperature, and the data demonstrates the content of over-lithiated material is approximately 63% in the powder.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The definitions of certain terms as used in this specification are provided below. Unless defined otherwise, all technical and scientific terms used herein generally have the same meaning as commonly understood by one of ordinary skill in the art to which this present technology belongs.

The following terms are used throughout as defined below.

As used herein and in the appended claims, singular articles such as “a”, “an”, and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, the terms “contain”, “contains”, or “containing” in the context of describing the elements (especially in the context of the following claims) are to be construed as comprising or including the elements being described herein.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Provided herein are electrochemical cells that are based on chemically or electrochemically over-lithiated cathodic active materials. It has been found that over-stoichiometric discharged lithium metal oxide electrode materials (Li/M >1; M=Ni, Co, Mn and/or other transition metals) may be used in lithium ion batteries as a means of introducing extra lithium electrochemically into lithium ion cells. Accordingly, the over-lithiated cathode active materials of the present technology are expected to increase the amount of available, cyclable lithium in the electrochemical cells and improve battery cycle life compared to conventional cathode active materials for lithium ion batteries.

In one aspect, a chemically over-lithiated cathode active material is provided. The chemically over-lithiated cathode active material may include a first lithium metal oxide phase of formula LiMetOₚ and a second lithium metal oxide phase of formula Li_{δ}MetOₚ, wherein Met is a transition metal or a mixture of transition metals; 1<δ≤2; and 0.5≤p≤8.

The transition metal or mixture of transitional metals, Met, may include one or more of Al, B, Co, Cr, Cu, Fe, Ga, Mg, Mn, Ni, Si, Ti, V, Zn, Zr, or a mixture of any two or more thereof. In some embodiments, Met may include a mixture of Co, Mn, and Ni.

In some embodiments, the first lithium metal oxide phase includes LiNi_{m′}Mn_{n′}Co_{o′}O_{p′}; and wherein 0≤m′<1; 0≤n′<1; 0≤o′<1; 0.5≤p′≤4; and where m′+n′+o′=1. In some embodiments, the first lithium metal oxide phase comprises LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In some embodiments, the first lithium metal oxide phase may have a substantially spinel structure. In some embodiments, the second lithium metal oxide phase may have a substantially layered structure.

In one aspect, an electrochemically over-lithiated cathode active material is provided. The electrochemically over-lithiated cathode active material may include a first lithium metal oxide phase of formula LiMetOₚ and a second lithium metal oxide phase of formula Li_{δ}MetOₚ, wherein Met is a transition metal or a mixture of transition metals; 1<δ≤2; and 0.5≤p≤8.

The transition metal or mixture of transitional metals, Met, may include one or more of Al, B, Co, Cr, Cu, Fe, Ga, Mg, Mn, Ni, Si, Ti, V, Zn, Zr, or a mixture of any two or more thereof. In some embodiments, Met may include a mixture of Co, Mn, and Ni.

In some embodiments, the first lithium metal oxide phase includes LiNi_{m′}Mn_{n′}Co_{o′}O_{p′}; and wherein 0≤m′<1; 0≤n′<1; 0≤o′<1; 0.5≤p′≤4; and where m′+n′+o′=1. In some embodiments, the first lithium metal oxide phase comprises LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In some embodiments, the first lithium metal oxide phase may have a substantially spinel structure. In some embodiments, the second lithium metal oxide phase may have a substantially layered structure.

In another aspect, the present disclosure is directed to a lithium ion battery that includes a non-aqueous electrolyte, an anode, and a cathode comprising any of the chemically over-lithiated cathode active materials disclosed herein.

In another related aspect, the present disclosure is directed to a lithium ion battery that includes a non-aqueous electrolyte, an anode, and a cathode comprising any of the electrochemically over-lithiated cathode active materials disclosed herein.

The lithium ion batteries of any embodiment disclosed herein may include an anode which includes, but is not limited to, layered structured materials of graphitic, carbonaceous, oxide or silicon, silicon-carbon composite, phosphorus-carbon composite, tin, tin alloys, silicon alloys, intermetallic compounds, lithium metal, sodium metal, or lithium titanium oxide. The anode may be stabilized by surface coating the active particles with a material. Hence the anodes can also comprise a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The anode may be further stabilized by surface coating the active particles with polymer materials. Examples of polymer coating materials include, but not limited to, polysiloxanes, polyethylene glycol, poly(3,4-ethylenedioxythiophene), polystyrene sulfonate, or a mixture of any two or more polymers.

In some embodiments, the anode of any of the lithium ion batteries disclosed herein may include natural graphite, synthetic graphite, hard carbon, amorphous carbon, soft carbon, mesocarbon microbeads, acetylene black, Ketjen black, carbon black, mesoporous carbon, porous carbon matrix, carbon nanotube, carbon nanofiber, graphene, silicon microparticle, silicon nanoparticle, silicon-carbon composite, silicon-graphite composite, tin microparticle, tin nanoparticle, tin-carbon composite, silicon-tin composite, phosphorous-carbon composites, lithium titanium oxide, lithium metal, sodium metal, lithium titanium oxide or magnesium metal.

The cathode, anode, or both the cathode and anode of any of the lithium ion batteries disclosed herein may further include a current collector. The current collector may include copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

In any embodiment disclosed herein, the electroactive materials of the cathode, anode, or both the cathode and anode disclosed herein may be applied to the current collector with a polymeric binder. In some embodiments, the electroactive materials and the polymeric binder are contacted with the current collector by casting, pressing, or rolling the mixture thereto.

When used, the polymeric binder may be present in the cathode, anode, or both the cathode and anode in an amount of from about 0.1 wt. % to about 99 wt. %. Thus, the polymeric binder may be present in the cathode, anode, or both the cathode and anode in an amount of from about 0.1 wt. %, about 0.11 wt. %, about 0.12 wt. %, about 0.13 wt. %, about 0.14 wt. %, about 0.15 wt. %, about 0.16 wt. %, about 0.17 wt. %, about 0.18 wt. %, about 0.19 wt. %, about 0.2 wt. %, about 0.22 wt. %, about 0.24 wt. %, about 0.26 wt. %, about 0.28 wt. %, about 0.3 wt. %, about 0.32 wt. %, about 0.34 wt. %, about 0.36 wt. %, about 0.38 wt. %, about 0.4 wt. %, about 0.42 wt. %, about 0.44 wt. %, about 0.46 wt. %, about 0.48 wt. %, about 0.5 wt. %, about 0.52 wt. %, about 0.54 wt. %, about 0.56 wt. %, about 0.58 wt. %, about 0.6 wt. %, about 0.62 wt. %, about 0.64 wt. %, about 0.66 wt. %, about 0.68 wt. %, about 0.7 wt. %, about 0.72 wt. %, about 0.74 wt. %, about 0.76 wt. %, about 0.78 wt. %, about 0.8 wt. %, about 0.82 wt. %, about 0.84 wt. %, about 0.86 wt. %, about 0.88 wt. %, about 0.9 wt. %, about 0.92 wt. %, about 0.94 wt. %, about 0.96 wt. %, about 0.98 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 2.2 wt. %, about 2.4 wt. %, about 2.6 wt. %, about 2.8 wt. %, about 3 wt. %, about 3.2 wt. %, about 3.4 wt. %, about 3.6 wt. %, about 3.8 wt. %, about 4 wt. %, about 4.2 wt. %, about 4.4 wt. %, about 4.6 wt. %, about 4.8 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 42 wt. %, about 44 wt. %, about 46 wt. %, about 48 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, about 99 wt. %, or any range including and/or in between any two of the preceding values. In some embodiments, the polymeric binder may be present in the cathode, anode, or both the cathode and anode in an amount of from about 5 wt. % to about 20 wt. %.

Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), a copolymer of any two or more such polymers, or a blend of any two or more such polymers. In some embodiments, the binder is an electrically conductive polymer such as, but not limited to, polythiophene, polyacetylene, poly(9,9-dioctylfluorene-co-fluorenone), poly(9,9-dioctylfluorene-co-fluorenone-co-methylbenzoic ester), or a copolymer of any two or more such conductive polymers.

The non-aqueous electrolyte may include an aprotic solvent and a metal salt. In some embodiments, the non-aqueous electrolyte may include an alkali metal salt. In some embodiments, the alkali metal salt may be a lithium salt or a sodium salt. Where a non-aqueous electrolyte is used, the non-aqueous electrolyte includes a polar aprotic solvent and a lithium metal salt. A variety of solvents may be employed in the electrolyte as the polar aprotic solvent. The electrolytes are substantially non-aqueous. As used herein, the term “substantially non-aqueous” means that the electrolytes do not contain water, or if water is present, it is only present at trace levels. For example, where the water is present at trace levels it is present at less than 20 ppm.

In any embodiment disclosed herein, the polar aprotic solvent may include liquids and gels capable of solubilizing sufficient quantities of the lithium salt and a redox shuttle so that a suitable quantity of charge can be transported from the positive electrode to negative electrode. In some embodiments, the solvents may be used over a wide temperature range, e.g., from about −30° C. to about 70° C. without freezing or boiling, and are stable in the electrochemical range within which the cell electrodes and shuttle operate. In some embodiments, the solvents may be used over a wide temperature range, e.g., from about −30° C., about −28° C., about −26° C., about −24° C., about −22° C., about −20° C., about −19° C., about −18° C., about −17° C., about −16° C., about −15° C., about −14° C., about −13° C., about −12° C., about −11° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 22° C., about 24° C., about 26° C., about 28° C., about 30° C., about 32° C., about 34° C., about 36° C., about 38° C., about 40° C., about 42° C., about 44° C., about 46° C., about 48° C., about 50° C., about 52° C., about 54° C., about 56° C., about 58° C., about 60° C., about 62° C., about 64° C., about 66° C., about 68° C., about 70° C., 6° C., about 6° C., or any range including and/or in between any two of the preceding values, without freezing or boiling, and are stable in the electrochemical range within which the cell electrodes and shuttle operate.

Illustrative solvents include, but are not limited to, ethylene carbonate, dimethyl carbonate, ethyl methyl carbonate, diethyl carbonate, methyl propyl carbonate, ethyl propyl carbonate, dipropyl carbonate, propylene carbonate, fluoroethylene carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, dioloxane, fluorinated oligomers, dimethoxyethane, a glyme, triglyme, dimethylvinylene carbonate, tetraethyleneglycol, dimethyl ether, polyethylene glycols, sulfones, γ-butyrolactone, δ-butyrolactone, a silane, a siloxane, siloxane N-methyl acetamide, acetonitrile, an acetal, a ketal, an ester, a carbonate, a sulfone, a sulfite, a sulfolane, an aliphatic ether, a cyclic ether, a polyether, a phosphate ester, an N-alkylpyrrolidone, adiponitrile, or a combination of any two or more thereof. In some embodiments, a fluorinated derivative of any solvent disclosed herein may be used.

Suitable salts for the electrolyte may include, but are not limited to, lithium alkyl fluorophosphates; lithium alkyl fluoroborates; lithium 4,5-dicyano-2-(trifluoromethyl)imidazole; lithium 4,5-dicyano-2-methylimidazole; trilithium 2,2′,2″-tris(trifluoromethyl)benzotris(imidazolate); Li(CF₃CO₂); Li(C₂F₅CO₂); LiCF₃SO₃; LiCH₃SO₃; LiN(SO₂CF₃)₂; LiC(CF₃SO₂)₃; LiN(SO₂C₂F₅)₂; LiClO₄; LiBF₄; LiAsF₆; LiPF₆; LiPF₂(C₂O₄)₂; LiPF₄(C₂O₄); LiB(C₂O₄)₂; LiBF₂(C₂O₄)₂; Li₂(B₁₂X₁₂₋ᵢHᵢ); Li₂(B₁₀X_{10-1′}H_{i′}); LiAlF₄; Li(FSO₂)₂N; Li₂SO₄; Na₂SO₄; NaPF₆; NaClO₄; LiAlO₂; LiSCN; LiBr; LiI; LiAsF₆; LiB(Ph)₄; Li₂S_{n″}; Li₂Se_{n″}; (LiS_{n″}R)_{y}; (LiSe_{n″}R)_{y}; or a combination of any two or more thereof wherein X is independently at each occurrence a halogen, I is independently at each occurrence an integer from 0 to 12, I′ is independently at each occurrence an integer from 0 to 10, n″ is independently at each occurrence an integer from 1 to 20, y is independently at each occurrence an integer from 1 to 3, and R is independently at each occurrence H, alkyl, alkenyl, aryl, ether, F, CF₃, COCF₃, SO₂CF₃, or SO₂F.

In any embodiment disclosed herein, the salt may be present in the electrolyte at a concentration from about 0.5M to about 2M. This may include, for example, from about 0.5M, about 0.52M, about 0.54M, about 0.56M, about 0.58M, about 0.6M, about 0.62M, about 0.64M, about 0.66M, about 0.68M, about 0.7M, about 0.72M, about 0.74M, about 0.76M, about 0.78M, about 0.8M, about 0.82M, about 0.84M, about 0.86M, about 0.88M, about 0.9M, about 0.92M, about 0.94M, about 0.96M, about 0.98M, about 1M, about 1.02M, about 1.04M, about 1.06M, about 1.08M, about 1.1M, about 1.12M, about 1.14M, about 1.16M, about 1.18M, about 1.2M, about 1.22M, about 1.24M, about 1.26M, about 1.28M, about 1.3M, about 1.32M, about 1.34M, about 1.36M, about 1.38M, about 1.4M, about 1.42M, about 1.44M, about 1.46M, about 1.48M, about 1.5M, about 1.52M, about 1.54M, about 1.56M, about 1.58M, about 1.6M, about 1.62M, about 1.64M, about 1.66M, about 1.68M, about 1.7M, about 1.72M, about 1.74M, about 1.76M, about 1.78M, about 1.8M, about 1.82M, about 1.84M, about 1.86M, about 1.88M, about 1.9M, about 1.92M, about 1.94M, about 1.96M, about 1.98M, about 2M, or any range including and/or in between any two of the preceding values.

In any embodiment disclosed herein, the electrolyte may also include a redox shuttle. The redox shuttle, if present, will have an electrochemical potential above the positive electrode's maximum normal operating potential. Illustrative redox shuttles include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano-2-(trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂(B₁₂X₁₂₋ᵢHᵢ), Li₂(B₁₀X_{10-1′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene, or a combination of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄.

In any embodiment disclosed herein, the cathode, anode, or both the cathode and anode may be further stabilized by surface coating the active particles with a material that can neutralize acid or otherwise lessen or prevent leaching of the transition metal ions. Hence, the cathode, anode, or both the cathode and anode may also include a surface coating of a metal oxide or a metal fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, CaO, In₂O₃, Ga₂O₃, Sc₂O₃, Y₂O₃, La₂O₃, HfO₂, V₂O₅, Nb₂O₅, Ta₂O₅, MnO, MnO₂, CoO, Co₂O₃, NiO, NiO₂, CuO, ZnO, MgF₂, CaF₂, Mo, Ta, W, Fe, Co, Cu, Ru, Pa, Pt, Al, Si, Se, oxyfluorides, a mixture of any two or more thereof, or any other suitable metal oxide or fluoride.

In any embodiment disclosed herein, the cathode, anode, or both the cathode and anode may be further stabilized by surface coating the active particles with polymer materials. Examples of polymer coating materials include, but are not limited to, polysiloxanes, polyethylene glycol, poly(3,4-ethylenedioxythiophene) polystyrene sulfonate, or a combination of any two or more thereof.

In any embodiment disclosed herein, the electrolyte may further include an electrode stabilizing additive. The electrode stabilizing additive is used to protect the electrodes from degradation. Examples of electrode stabilizing additives may be found in US Patent Publication Nos. 2005/0019670 A1, 2006/0134527 A1, and 2006/0147809 A1, of which the entire contents are incorporated herein by reference. Hence, the electrode stabilizing additive which may be included herein may be reduced or polymerized on the surface of the negative electrode. Likewise, the electrode stabilizing additive which may be included herein may be oxidized or polymerized on the surface of the positive electrode.

In any embodiment disclosed herein, the electrolyte may include about 0.001 wt. % to about 8 wt. % of the electrode stabilizing additive. This may include, for example, about 0.001 wt. %, about 0.002 wt. %, about 0.003 wt. %, about 0.004 wt. %, about 0.005 wt. %, about 0.006 wt. %, about 0.007 wt. %, about 0.008 wt. %, about 0.009 wt. %, about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.15 wt. %, about 0.2 wt. %, about 0.25 wt. %, about 0.3 wt. %, about 0.35 wt. %, about 0.4 wt. %, about 045 wt. %, about 0.5 wt. %, about 0.55 wt. %, about 0.6 wt. %, about 0.65 wt. %, about 0.7 wt. %, about 0.75 wt. %, about 0.8 wt. %, about 0.85 wt. %, about 0.9 wt. %, about 0.95 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, about 5 wt. %, about 5.1 wt. %, about 5.2 wt. %, about 5.3 wt. %, about 5.4 wt. %, about 5.5 wt. %, about 5.6 wt. %, about 5.7 wt. %, about 5.8 wt. %, about 5.9 wt. %, about 6 wt. %, about 6.1 wt. %, about 6.2 wt. %, about 6.3 wt. %, about 6.4 wt. %, about 6.5 wt. %, about 6.6 wt. %, about 6.7 wt. %, about 6.8 wt. %, about 6.9 wt. %, about 7 wt. %, about 7.1 wt. %, about 7.2 wt. %, about 7.3 wt. %, about 7.4 wt. %, about 7.5 wt. %, about 7.6 wt. %, about 7.7 wt. %, about 7.8 wt. %, about 7.9 wt. %, about 8 wt. %, or any range including and/or in between any two of the preceding values, of the electrode stabilizing additive.

In any embodiment disclosed herein, the electrode stabilizing additive may include 1,2-divinyl furoate, 1,3-butadiene carbonate, 1-vinylazetidin-2-one, 1-vinylaziridin-2-one, 1-vinylpiperidin-2-one, 1-vinylpyrrolidin-2-one, 2,4-divinyl-1,3-dioxane, 2-amino-3-vinylcyclohexanone, 2-amino-3-vinylcyclopropanone, 2-amino-4-vinylcyclobutanone, 2-amino-5-vinylcyclopentanone, 2-aryloxy-cyclopropanone, 2-vinyl-[1,2]oxazetidine, 2-vinylaminocyclohexanol, 2-vinylaminocyclopropanone, 2-vinyloxetane, 2-vinyloxy-cyclopropanone, 3-(N-vinylamino)cyclohexanone, 3,5-divinyl furoate, 3-vinylazetidin-2-one, 3-vinylaziridin-2-one, 3-vinylcyclobutanone, 3-vinylcyclopentanone, 3-vinyloxaziridine, 3-vinyloxetane, 3-vinylpyrrolidin-2-one, 4,4-divinyl-3-dioxolan-2-one, 4-vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl carbonate, 1,2-diphenyl ether, vinyl ethylene silicate, vinyl ethylene sulfate, vinyl ethylene sulfite, vinyl methacrylate, vinyl phosphate, vinyl-2-furoate, vinylcylopropanone, vinylethylene oxide, or a combination of any two or more thereof. In some embodiments, the electrode stabilizing additive may be vinyl ethylene carbonate, vinyl carbonate, 1,2-diphenyl ether, or a combination of any two or more thereof.

In any embodiment disclosed herein, the electrode stabilizing additive may be a cyclotriphosphazene that is substituted with F, alkyloxy, alkenyloxy, aryloxy, methoxy, allyloxy groups, or a combination of any two or more thereof. Illustrative electrode stabilizing additives may include, but are not limited to (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene, or a combination of any two or more thereof.

In any embodiment disclosed herein, the electrode stabilizing additive may include compounds with phenyl, naphthyl, anthracenyl, pyrrolyl, oxazolyl, furanyl, indolyl, carbazolyl, imidazolyl, or thiophenyl groups. Illustrative electrode stabilizing additives may include, but are not limited to, aryloxy pyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydro-furan-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4-divinyl-1-methyl pyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cycolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxy-quinoline, diaryloxy-cyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o terphenyl, N-methyl pyrrole, naphthalene, or a combination of any two or more thereof.

In any embodiment disclosed herein, the electrode stabilizing additives may include substituted or unsubstituted spirocyclic hydrocarbons which may contain at least one oxygen atom and at least one alkenyl or alkynyl group. Illustrative electrode stabilizing additives include, but are not limited to, a compound represented by the Formula X:

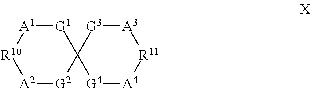

wherein A¹, A², A³, and A⁴ are independently at each occurrence O or CR¹²R¹³; provided that A¹ is not O when G¹ is O, A² is not O when G² is O, A³ is not O when G³ is O, and A⁴ is not O when G⁴ is O; G¹, G², G³, and G⁴ are independently at each occurrence O or CR¹²R¹³; provided that G¹ is not O when A¹ is O, G² is not O when A² is O, G³ is not O when A³ is O, and G⁴ is not O when A⁴ is O; R¹⁰ and R¹¹ are independently at each occurrence a substituted or unsubstituted divalent alkenyl or alkynyl group; and R¹² and R¹³ are independently at each occurrence H, F, Cl, or a substituted or an unsubstituted alkyl, alkenyl, or alkynyl group.

Illustrative compounds of Formula X include, but are not limited to, 3,9 divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9 diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9 dimethylene-1,5,7,11-tetraoxaspiro[5.5]undecane, 3,9 diethylidene-1,5,7,11-tetraoxaspiro[5.5]undecane, or a combination of any two or more thereof.

In any embodiment disclosed herein, the electrode stabilizing additive may be an anion receptor. In some embodiments, the anion receptor is a Lewis acid. In some embodiments, the anion receptor is a borane, a boronate, a borate, a borole, or a combination of any two or more thereof. Illustrative anion receptors include, but are not limited to, a compound represented by the Formula XI:

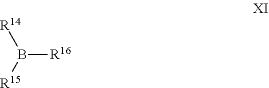

wherein R¹⁴, R¹⁵, and R¹⁶ are independently at each occurrence halogen, alkyl, aryl, halogen-substituted alkyl, halogen-substituted aryl, or OR¹⁷; or any two of R¹⁴, R¹⁵, R¹⁶, and R¹⁷, together with the atoms to which they are attached, form a heterocyclic ring having 5-9 members, and R¹⁷ is independently at each occurrence alkyl, aryl, halogen-substituted alkyl, or halogen-substituted aryl. In some embodiments, R¹⁴, R¹⁵, and R¹⁶ are independently at each occurrence halogen, alkyl, aryl, halogen-substituted alkyl, or halogen-substituted aryl; or any two of R¹⁴, R¹⁵, and R¹⁶, together with the atoms to which they are attached, form a heterocyclic ring having 5-9 members.

In any embodiment disclosed herein, the anion receptor may be tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a combination of any two or more thereof. In some embodiments, the anion receptor may be one or more of 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3, 5-difluorophenylboronate, bis(1,1,1,3,3,3-hexafluoroisopropyl) pentafluorophenylboronate, or a mixture of any two or more such compounds.

In any embodiment disclosed herein, the lithium ion batteries disclosed herein may further include a porous separator. The porous separator may separate the cathode from the anode and prevent, or at least minimize, short-circuiting in the device. The separator may be a polymer or ceramic or a mixed separator. The separator may include, but is not limited to, polypropylene (PP), polyethylene (PE), trilayer (PP/PE/PP), or polymer films that may optionally be coated with alumina-based ceramic particles.

In another aspect, processes are provided for preparing the chemically over-lithiated cathode active materials above. The processes may include contacting lithium-ammonia or lithium naphthalenide with a lithium metal oxide cathode active material or a metal oxide cathode active material to form the chemically over-lithiated cathode active material. In some embodiments, the chemically over-lithiated cathode active material may include a first lithium metal oxide phase and a second lithium metal oxide phase that is different from the first lithium metal oxide phase.

As noted above, the process for preparing the chemically over-lithiated cathode active materials may include contacting and/or reacting a lithium source with a lithium metal oxide cathode active material or a metal oxide cathode active material. In some embodiments, the process may include contacting the lithium-ammonia with the lithium metal oxide cathode active material or the metal oxide cathode active material. In some embodiments, the process may include contacting the lithium naphthalenide with the lithium metal oxide cathode active material or the metal oxide cathode active material. In the processes using lithium naphthalenide, the over-lithiated cathode material is prepared at about room temperature.

The chemically over-lithiated cathode active material may be prepared via chemical lithiation with liquid ammonia, using a lecture bottle station (Sigma Aldrich, St. Louis, Mo.). About 30 mL of liquid ammonia will be condensed from an ammonia gas cylinder (anhydrous >99.99%, Sigma-Aldrich, St. Louis, Mo.) into a dry, argon purged round-bottom flask coupled with a cold finger condenser (Sigma-Aldrich). The condenser will be kept cool by addition of dry ice to 2-propanol (Thermo Fisher Scientific, Waltham, Mass.). The liquid ammonia and the LiNi_{0.5}Mn_{1.5}O₄ (˜1 g, LNMO) material (NEI Corporation, Somerset, N.J.) will be added to the flask while maintaining a positive pressure of argon in the flask and exposure to the atmosphere will be minimized. Small pieces of Li metal chips (MTI Corporation, Richmond, Calif.) will be weighed and slowly added to the reaction vessel, allowing time for each chip to dissolve and react with the LNMO powder. The amount of lithium added will control the amount of lithium inserted into the LNMO structure. The reaction will take place over a 6 h period, during which the reaction vessel will be kept cool by the addition of dry ice to 2-propanol in a surrounding hemispherical Dewar (Sigma-Aldrich). Subsequently, the ammonia will be allowed to evaporate by allowing the system to slowly increase in temperature. The reaction vessel will then be transferred to an argon filled glove box (O₂ and H₂O <1 ppm), without exposing the products to the atmosphere. The resulting powder will be removed from the flask and washed in methanol (anhydrous ≥99.8%, Sigma-Aldrich) until the pH of the solution is neutral. The collected lithiated LNMO powders (LLNMO) will be dried at room temperature and stored in an argon glove box.

In some embodiments, the lithium metal oxide cathode active material includes a compound of formula Li_{δ}(M¹_{y}Mn_{2-y})Oₚ, Li_{δ}(M²_{y})Oₚ, Li_{δ}(M²_{y}M³_{2-y})Oₚ, or Li_{δ}(M¹_{y′}R¹ₐ)O_{p′}; wherein M¹ is Cr, Fe, Co, Ni, Cu, or a mixture of any two or more thereof; M² is Fe, Co, Ni, Mn, Ti, V, or a mixture of any two or more thereof; M³ is different from M² and is Fe, Co, Ni, Mn, Ti, V, or a mixture of any two or more thereof; R¹ is O, OH, F, Cl, Br, S or I; wherein 0<y<2; 1≤y′≤3; 0<p≤4; 0<p′≤8; 0<δ≤2; and 0≤a≤1.

In some embodiments, the lithium metal oxide cathode active material includes LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof. In some embodiments, the lithium metal oxide cathode active material comprises LiMn₂O₄, LiNi_{0.5}Mn_{1.5}O₄, or LiNi_{0.5}Mn_{0.3}Co_{0.2}O₄. In some embodiments, the metal oxide cathode active material includes V₂O₅, MnO₂, FeOF, FeF₃, or a combination of any two or more thereof.

As noted above, the processes for preparing the chemically over-lithiated cathode active materials may give rise to a chemically over-lithiated cathode active material that includes a first lithium metal oxide phase and a second lithium metal oxide phase that is different from the first lithium metal oxide phase.

In some embodiments, the first lithium metal oxide phase includes LiNi_{m′}Mn_{n′}Co_{o′}O_{p′}; and wherein 0≤m′<1; 0≤n′<1; 0≤o′<1; 0.5≤p′≤4; and where m′+n′+o′=1. In some embodiments, the first lithium metal oxide phase comprises LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In another aspect, provided herein are the chemically over-lithiated cathode active materials of any embodiment disclosed herein.

In another aspect, a process is provided for preparing the electrochemically over-lithiated cathode active materials above. The process may include cycling a half cell comprising a lithium metal oxide cathode active material or a metal oxide cathode active material, and a lithium metal counter electrode to form the electrochemically over-lithiated cathode active material.

As noted above, the processes for preparing the electrochemically over-lithiated cathode active materials may give rise to an electrochemically over-lithiated cathode active material that may include a first lithium metal oxide phase and a second lithium metal oxide phase that is different from the first lithium metal oxide phase.

The electrochemically over-lithiated cathode active material may be prepared via electrochemical lithiation of LiNi_{0.5}Co_{0.2}Mn_{0.3}O₂ (NCM523) positive electrodes. The positive electrodes will have a composition that may include about 90 wt. % NCM523 (Toda Advanced Materials, Ontario, Canada), about 5 wt. % C-45 conductive carbon, and about 5 wt. % polyvinylidene fluoride (PVDF) as a binder. The negative electrodes may be a Si-graphite electrode that may include about 15 wt. % Si (Paraclete Energy, Chelsea, Mich.), about 73 wt. % graphite (Hitachi MAGE), about 2 wt. % C-45 carbon, and about 10 wt. % lithium polyacrylate (LiPAA) as a binder. The electrodes will be punched, 14 mm for the positive electrode and 15 mm for the negative electrode, and dried in an oven overnight at 75° C. and 150° C., respectively. The loading of the positive electrode will be about 10.2(2) mg cm⁻² (1.86(3) mg cm⁻²), and the loading of the negative electrode will be about 2.8(2) mg cm⁻² (2.80(1) mg cm⁻²). Electrochemical measurements will be performed in 2032-type coin cells that will be assembled in an argon-filled glovebox with oxygen levels less than 1 ppm. Cells will be built with 45 μL of non-aqueous electrolyte. Half-cell measurements will use 15.6 mm diameter lithium metal chips (MTI) as a reference/counter electrode. All electrochemical tests will be performed at 30° C. using a MACCOR Series 4000 Test System (MACCOR). Half-cells will be cycled between 4.5-3.0 Vat C/10 for NCM523, and between 1.5-0.1 Vat C/10 for Si-graphite. Electrochemical lithiation of NCM523 will be conducted in a half-cell configuration, where the cathode will be discharged to a pre-determined capacity (e.g., 20, 40, 60, 80, or 100 mAh g⁻¹_{NCM}) or potential (1.1 V) limitation. In the discharged state and in an argon filled glovebox the cell will be decrimped, and the electrochemically over-lithiated cathode active material will be extracted from the cell and immediately rebuilt into a Li₁₊ₓNCMO₂/Si-graphite full cell. Li₁₊ₓNCMO₂/Si-graphite full cell performance will then be evaluated in a 3.0-4.1 V potential window. The cycling protocol for 100 cycles, may consist of three C/20 formation cycles, 94 C/3 aging cycles, and three C/20 diagnostic cycles. The first and last C/3 cycles will apply a hybrid pulse power characterization (HPPC) test on discharge to measure the DC impedance. At pre-determined cell voltages, a 3 C, 10 s discharge pulse followed 40 s later by a 2.5 C, 10 s charge pulse will be applied; at each voltage the cell will be allowed to equilibrate for 1 h prior to the first 10 s pulse.

In some embodiments, the lithium metal oxide cathode active material includes a compound of formula Li_{δ}(M¹_{y}Mn_{2-y})Oₚ, Li_{δ}(M²_{y})Oₚ, Li_{δ}(M²_{y}M³_{2-y})Oₚ, or Li_{δ}(M¹_{y′}R¹ₐ)O_{p′}; wherein M¹ is Cr, Fe, Co, Ni, Cu, or a mixture of any two or more thereof; M² is Fe, Co, Ni, Mn, Ti, V, or a mixture of any two or more thereof; M³ is different from M² and is Fe, Co, Ni, Mn, Ti, V, or a mixture of any two or more thereof; R¹ is O, OH, F, Cl, Br, S or I; wherein 0<y<2; 1≤y′≤3; 0<p≤4; 0<p′≤8; 0<δ≤2; and 0≤a≤1.

In some embodiments, the lithium metal oxide cathode active material includes LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof. In some embodiments, the lithium metal oxide cathode active material comprises LiMn₂O₄, LiNi_{0.5}Mn_{1.5}O₄, or LiNi_{0.5}Mn_{0.3}Co_{0.2}O₄. In some embodiments, the metal oxide cathode active material includes V₂O₅, MnO₂, FeOF, FeF₃, or a combination of any two or more thereof.

As noted above, the processes for preparing the electrochemically over-lithiated cathode active materials may give rise to an electrochemically over-lithiated cathode active material that includes a first lithium metal oxide phase and a second lithium metal oxide phase that is different from the first lithium metal oxide phase.

In some embodiments, the first lithium metal oxide phase includes LiNi_{m′}Mn_{n′}Co_{o′}O_{p′}; and wherein 0≤m′<1; 0≤n′<1; 0≤o′<1; 0.5≤p′≤4; and where m′+n′+o′=1. In some embodiments, the first lithium metal oxide phase comprises LiNi_{0.5}Co_{0.2}Mn_{0.3}O₂.

In some embodiments, the second lithium metal oxide phase includes Li_{δ}Ni_{m′}Mn_{n′}Co_{o′}O_{p′}; and wherein 1<δ≤2; 0≤m′<1; 0≤n′<1; 0≤o′<1; 0.5≤p′≤4; and where m′+n′+o′=1. In some embodiments, the second lithium metal oxide phase includes Li_{δ}Ni_{0.5}Co_{0.2}Mn_{0.3}O₂, wherein 1<δ≤2.

In some embodiments, the first lithium metal oxide phase may have an interlayer distance (d) of about 2.606 Å to about 2.624 Å. Thus, the first lithium metal oxide phase may have an interlayer distance (d) of about 2.606 Å, about 2.607 Å, about 2.608 Å, about 2.609 Å, about 2.610 Å, about 2.611 Å, about 2.612 Å, about 2.613 Å, about 2.614 Å, about 2.615 Å, about 2.616 Å, about 2.617 Å, about 2.618 Å, about 2.619 Å, about 2.620 Å, about 2.621 Å, about 2.622 Å, about 2.623 Å, about 2.624 Å, or any range including and/or in between any two of the preceding values.

In some embodiments, the first lithium metal oxide phase may have a lattice parameter (c) of about 14.320 Å to about 14.340 Å. Thus, the first lithium metal oxide phase may have a lattice parameter (c) of about 14.320 Å, about 14.322 Å, about 14.324 Å, about 14.326 Å, about 14.328 Å, about 14.330 Å, about 14.332 Å, about 14.334 Å, about 14.336 Å, about 14.338 Å, about 14.340 Å, or any range including and/or in between any two of the preceding values.

In some embodiments, the second lithium metal oxide phase may have an interlayer distance (d) of about 2.51 Å to about 2.70 Å. Thus, the second lithium metal oxide phase may have an interlayer distance (d) of about 2.51 Å, about 2.52 Å, about 2.53 Å, about 2.54 Å, about 2.55 Å, about 2.56 Å, about 2.57 Å, about 2.58 Å, about 2.59 Å, about 2.60 Å, about 2.61 Å, about 2.62 Å, about 2.63 Å, about 2.64 Å, about 2.65 Å, about 2.66 Å, about 2.67 Å, about 2.68 Å, about 2.69 Å, about 2.70 Å, or any range including and/or in between any two of the preceding values.

In some embodiments, the second lithium metal oxide phase may have a lattice parameter (c) of about 5.070 Å to about 5.303 Å. Thus, the second lithium metal oxide phase may have a lattice parameter (c) of about 5.070 Å, about 5.075 Å, about 5.080 Å, about 5.085, about 5.090 Å, about 5.095 Å, about 5.100 Å, about 5.110 Å, about 5.120 Å, about 5.130 Å, about 5.140 Å, about 5.150 Å, about 5.160 Å, about 5.170 Å, about 5.180 Å, about 5.190 Å, about 5.200 Å, about 5.210 Å, about 5.220 Å, about 5.230 Å, about 5.240 Å, about 5.250 Å, about 5.260 Å, about 5.270 Å, about 5.280 Å, about 5.290 Å, about 5.300 Å, about 5.303 Å, or any range including and/or in between any two of the preceding values.

In another aspect, provided herein are the electrochemically over-lithiated cathode active materials of any embodiment disclosed herein.

### EXAMPLES

The present technology is further illustrated by the following Example, which should not be construed as limiting in any way. The examples herein are provided to illustrate advantages of the present technology and to further assist a person of ordinary skill in the art with preparing or using the compositions and systems of the present technology. The examples should in no way be construed as limiting the scope of the present technology, as defined by the appended claims. The examples can include or incorporate any of the variations, aspects, or embodiments of the present technology described above. The variations, aspects, or embodiments described above may also further each include or incorporate the variations of any or all other variations, aspects or embodiments of the present technology.

### Example 1

The LiNi_{0.5}Mn_{1.5}O₄ (LNMO) material was obtained from NEI used in this work was obtained from NEI Corporation (Somerset, N.J.). The chemical lithiation reaction with liquid ammonia was carried out using a lecture bottle station (Sigma Aldrich, St. Louis, Mo.). Approximately 30 mL of liquid ammonia was first condensed from an ammonia gas cylinder (anhydrous >99.99%, Sigma-Aldrich) in a dry and argon purged round-bottom flask coupled with a cold finger condenser (Sigma-Aldrich). The condenser was kept cool by addition of dry ice to 2-propanol (Thermo Fisher Scientific, Waltham, Mass.). Reagents were added to the flask while maintaining a positive pressure of argon in the flask and exposure to the atmosphere was minimized. While stirring with a magnetic stirrer, about 1 g of LNMO powder was added and allowed to disperse thoroughly in the ammonia. Small pieces of Li metal chips (MTI Corporation, Richmond, Calif.) were weighed and slowly added to the reaction vessel, allowing time for each chip to dissolve and react with the LNMO powder. The amount of lithium added controlled the amount of lithium inserted into the LNMO structure. The reaction took place over an approximately 6 h period, during which the reaction vessel was kept cool by addition of dry ice to 2-propanol in a surrounding hemispherical Dewar (Sigma-Aldrich). Subsequently, the ammonia was allowed to evaporate by allowing the system to slowly increase in temperature. The reaction vessel was transferred to an argon filled glove box (O₂ and H₂O <1 ppm), without exposing the products to the atmosphere. The resulting powder was removed from the flask and washed in methanol (anhydrous ≥99.8%, Sigma-Aldrich) until the pH of the solution was neutral. The collected lithiated LNMO powders (LLNMO) were dried at room temperature and stored in an argon glove box.

The cathodes in this work were prepared by casting a slurry of 84 wt. % cathode active material (LNMO or LLNMO), 8 wt. % conductive carbon (Super P, Timcal), and 8 wt. % polyvinylidene fluoride binder (PVDF, Solvay USA Inc., Albright, W. Va.) in N-methyl-2-pyrrolidone (NMP, ≥99.0%, Sigma-Aldrich) solvent onto 20 μm thick Al foil. Slurry preparation and electrode casting were performed in an air atmosphere to determine the air stability of the lithiated materials. Cathodes were then dried under vacuum at 75° C. prior to use. Graphite anodes were prepared in a similar manner, with a ratio of 90 wt. % graphite (Hitachi MAGE), 2 wt. % conductive carbon (C45, Timcal), and 8 wt. % PVDF. Si-graphite composite electrodes were supplied by the Cell Analysis Modelling and Prototyping facility (CAMP), which include 73 wt. % graphite, 15 wt. % silicon (Nano-Amor, 50-70 nm), 2 wt. % conductive carbon (C45), and 10 wt. % lithiated polyacrylic acid binder (LiPAA, from 450 k mol wt. PAA [Sigma-Aldrich] titrated against LiOH to pH 5.5-6.5). Graphite and Si-graphite electrodes were dried under vacuum at 120° C. and 150° C., respectively, before use.

Electrodes were punched with a 1.43 cm diameter and built into CR2032 coin cells (Hohsen Corporation, Tokyo, Japan) in both half- and full-cell configurations. Li chips (15.9 mm diameter, MTI) were used in half-cell tests. An electrolyte with 1.2 M LiPF₆ in ethylene carbonate (EC):ethyl methyl carbonate (EMC), 3:7 wt/wt (Tomiyama) was generally used. Cells containing a Si-graphite electrode used the above electrolyte with additive 10 wt. % fluoroethylene carbonate (FEC, Solvay). Electrochemical cycling was conducted on a MACCOR series 4000 battery testing unit (MACCOR, Tulsa, Okla.). Half-cells with LNMO or LLNMO were cycled between 4.95-3.5 V at C/10 (1C=148 mAh g⁻¹_{LNMO}). Graphite and Si-graphite half-cells were cycled between 1.5-0.01 V and 1.5-0.05 V, respectively, at C/10 (graphite 1C=350 mAh g⁻¹, Si-graphite 1C=750 mAh g⁻¹_{Si-graphite}). Full cells were cycled at C/10 (1C=148 mAh g⁻¹ by cathode active mass, ˜0.044 mA cm⁻²) between 4.8-3.4 V at room temperature for graphite containing cells, and 4.8-3.45 V at 30° C. for Si-graphite cells. Cells were balanced by controlling the thickness of the electrode. The mass loading of the LNMO and LLNMO paired with graphite was ˜2.0 mg cm⁻², and ˜3.0 mg cm⁻² when paired with Si-graphite. Graphite loading was ˜1.1 mg cm⁻² and Si-graphite loading was ˜0.7 mg cm⁻².

The structure of the pristine and lithiated LNMO was confirmed by high-resolution synchrotron X-ray diffraction (XRD) at beamline 11-BM at the Advanced Photon Source (APS) at Argonne National Laboratory (Argonne, (λ=0.41266 Å or 0.414534 Å)). Scanning electron microscope (SEM) images were captured using a Hitachi S-4700-II microscope in the Electron Microscopy Center of Argonne. The Li, Ni and Mn molar ratio was analyzed using an Inductively Coupled Plasma Mass Spectrometry (ICP-MS) DRCII (Perkin Elmer, Waltham, Mass.). The LNMO or LLNMO powder was dissolved in concentrated HNO₃/HCl and diluted to the low ppb level for measurement. Rietveld refinements were performed using GSAS-II (see Toby, B. H. et al. J. Appl. Crystallogr. 46:544-549 (2013)).

### Example 2

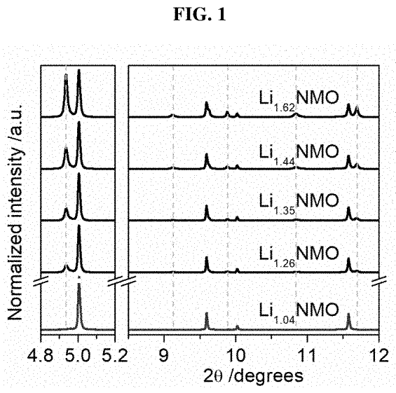

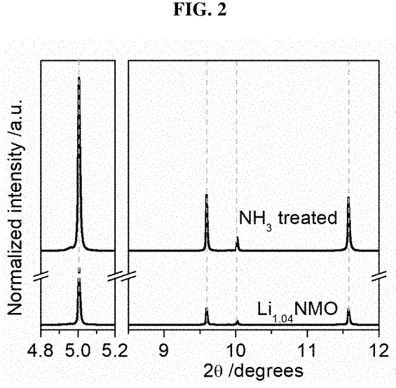

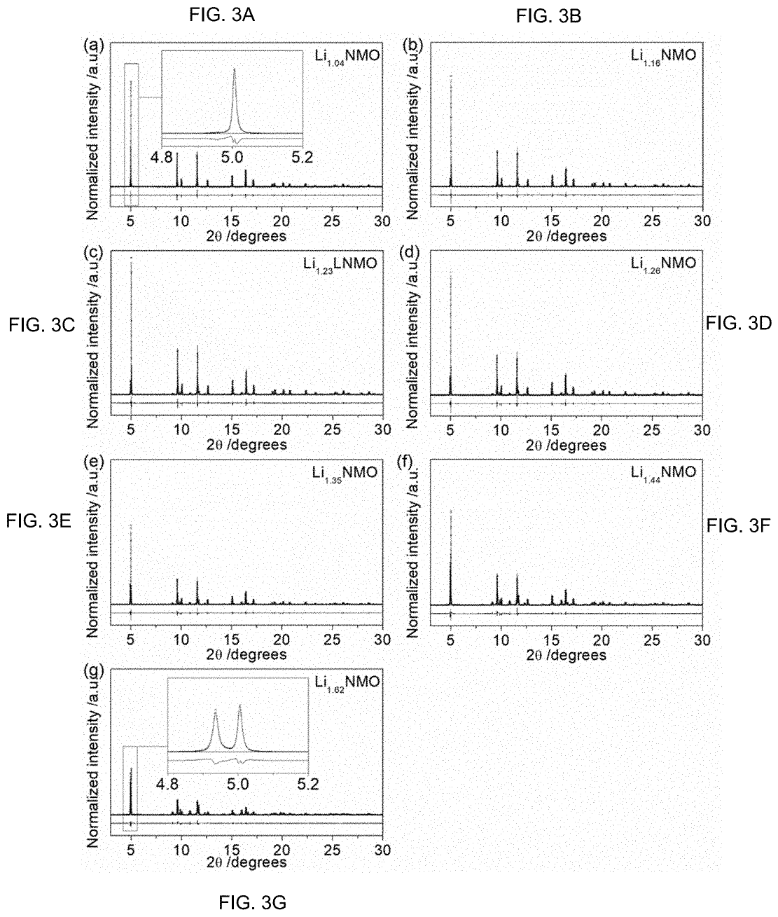

The solution of lithium metal and ammonia is a deep blue color, consisting of an ammonia complexed lithium cation and a solvated electron ([Li(NH₃)ₓ]⁺,e⁻) known as an electride salt. This solution is a powerful reducing agent that, in contact with LNMO, will reduce Mn⁴⁺ to Mn³⁺. To provide change compensation, lithium ions are inserted into the structure thereby lithiating the LNMO. The impact of the ammonia treatment on the crystal structure of LNMO was determined. The pristine material (LNMO) was stirred in ammonia for the same time as the lithiation experiments, but lithium metal was not added. XRD patterns of the pristine and ammonia treated LNMO demonstrated no change from immersion in ammonia (FIG. 2). To confirm lithium insertion into the LNMO spinel structure during the lithiation experiments x-ray powder diffraction (XRD), inductively couple plasma mass spectrometry (ICP-MS), and electrochemical testing were performed. XRD patterns of the LNMO and lithiated LNMO (LLNMO) after washing with anhydrous methanol are illustrated in FIG. 1. All the peaks in the XRD pattern of the pristine material, with lithium content Li_{1.04}NMO as determined by ICP-MS, can be assigned to a face-centered cubic phase with Fd-3m space group. As the amount of lithium inserted into LNMO material increases, the intensity for reflections associated with the tetragonal Li₂M₂O₄ phase also increased (in this case M=Ni, Mn, FIG. 1), most notably at 4.94, 9.12, 9.88, 10.84 and 11.69° 2θ (d spacing 4.79, 2.60, 2.40, 2.18, 2.03 Å). Rietveld analysis of the patterns (FIG. 3) demonstrated constant lattice parameters for the cubic Li₁NMO and tetragonal Li₂NMO phases (a_{c}=8.1829±0.0011 Å, aₜ=5.7306±0.0010 Å, cₜ=8.7281±0.0072 Å, where c and t represent cubic and tetragonal, respectively) with varying lithium content, indicative of a two-phase lithiation process. Refinement also demonstrated that the weight fraction of the tetragonal Li₂NMO phase increases with lithium content (Table 1) at the expense of the cubic Li₁NMO phase.

TABLE 1
Stoichiometry of LiNi_{0.5}Mn_{1.5}O₄ and chemically lithiated Li₁₊ₓNi_{0.5}Mn_{1.5}O₄.

| | | | | Calculated Mn | | Tetragonal |
|---|---|---|---|---|---|---|
| Targeted | ICP stoichiometry | | | fraction | | spinel wt. |
| stoichiometry | Li | Ni | Mn | Mn (III) | Mn (IV) | fraction |
| LiNi_{0.5}Mn_{1.5}O₄ | 1.04 (2) | 0.480 (1) | 1.520 (1) | 0.05 | 0.95 | — |
| Li_{1.4}Ni_{0.5}Mn_{1.5}O₄ | 1.26 (3) | 0.493 (1) | 1.507 (2) | 0.18 | 0.82 | 0.217 (1) |
| Li_{1.5}Ni_{0.5}Mn_{1.5}O₄ | 1.35 (2) | 0.491 (1) | 1.509 (1) | 0.24 | 0.76 | 0.303 (1) |
| Li_{1.6}Ni_{0.5}Mn_{1.5}O₄ | 1.44 (3) | 0.488 (7) | 1.512 (7) | 0.31 | 0.69 | 0.409 (1) |
| Li_{1.9}Ni_{0.5}Mn_{1.5}O₄ | 1.62 (1) | 0.495 (5) | 1.504 (5) | 0.42 | 0.58 | 0.546 (1) |

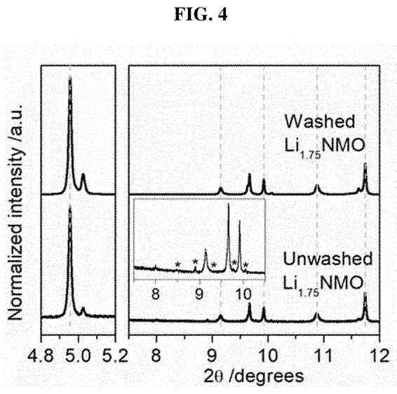

Lithiated samples that have not been washed with anhydrous methanol demonstrated the presence of a lithium hydroxide (LiOH) impurity in the high-resolution XRD pattern (FIG. 4). Washing effectively removes this impurity. The presence of LiOH likely arose from the reaction of residual lithium amide (LiNH₂) formed during synthesis with trace levels of moisture in the glove box. A second observation from FIG. 4 is a small change in the relative intensity of the tetragonal Li₂NMO 101 reflection compared to the cubic Li₁NMO 111 reflection at 4.94 and 5.01° 2θ, respectively. This demonstrated that anhydrous methanol washing has the effect of slightly delithiating the material, and subsequently converting a small fraction of the lithium-rich tetragonal phase to the cubic phase.

Results from ICP-MS of the metal content in the pristine (LNMO) and lithiated (LLNMO) samples are illustrated in Table 1, along with the targeted stoichiometry. In all cases, the measured lithium content was lower than that targeted. This was consistent with the finding that lithium salts are removed from the samples during washing with the anhydrous methanol. In fact, the measured lithium content tracked linearly with the targeted content, with a slope of 0.66(1) and y-intercept of 0.02(1) (FIG. 4, r²=0.998). Using the chemical lithiation method of the present technology, the highest achieved lithium content was Li_{1.96}NMO. Adding additional lithium to the reaction was ineffective at lithiating the material beyond the apparent Li₂NMO limit. Based on the ICP-MS results, the fraction of Mn³⁺ and Mn⁴⁺ in the structure was calculated, assuming Ni²⁺ (Table 1). In the Li_{1.62}NMO, the highest lithium content employed in this work, the fraction of Mn³⁺ was determined to be 42%. This introduced Jahn-Teller distortion associated with high spin of Mn³⁺((t_{2g})³ (e_{g}*)¹). Repeated formation of Mn³⁺ has been linked to structural degradation and rapid capacity fade in these materials (see Sun, Y. K. et al. J. Mater. Chem. 9:3147-3150 (1999)), and therefore it is best avoided. This effect has been minimized by oxidizing the Mn³⁺ to Mn⁴⁺ on the first charge of the cell (delivering the extra lithium from the cathode to the anode) and then limiting the potential window to ensure Mn⁴⁺ is not reduced on discharge.

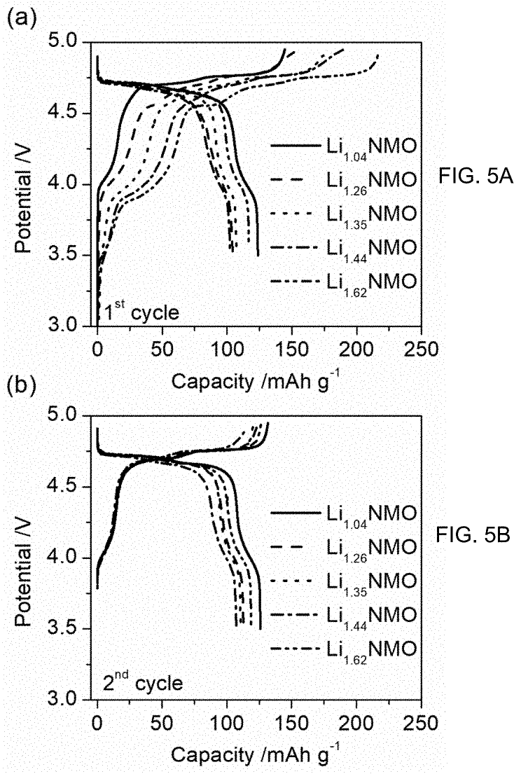

Electrochemical tests were also performed to verify the amount of electrochemically available lithium chemically inserted into the LLNMO. Upon charge, the pristine Li_{1.04}NMO exhibited a capacity of 145 mAh g⁻¹ with plateaus at 4.71 and 4.76 V versus Li/Li⁺ (FIG. 5). There is also a short sloping feature at ˜4 V, which has been attributed to oxidation of a small amount of Mn³⁺ present. As displayed in FIG. 5, the first charge capacity increased with the insertion of extra lithium. Extra lithium was mostly extracted in a sloping voltage feature at 3.8-4.0 V, although there is an additional feature at ˜3.5 V and a plateau at 4.55 V that was absent in the Li_{1.04}NMO potential profile. Li_{1.62}NMO demonstrated a first charge capacity of 217 mAh g⁻¹. Therefore, XRD, ICP-MS and electrochemistry experiments all confirmed that extra lithium was inserted into the spinel structure of LNMO. Further, this extra lithium was electrochemically available, as it was available for extraction on the first charge and used to mitigate the first cycle irreversibility of the anode in full cells.

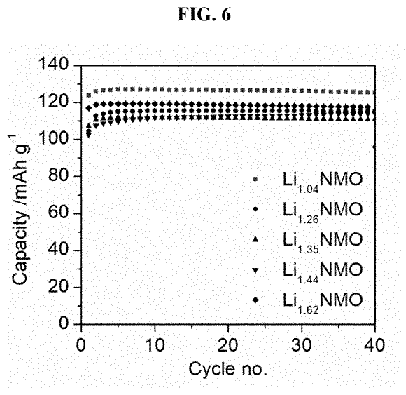

The reversibility and cycle stability of the LLNMO was compared with the baseline LNMO prior to testing the performance of these lithiated cathode materials in full cells. Consideration of the potential profile on the first cycle discharge (FIG. 5) highlighted the relative reversibility of Li_{1.04}NMO and LLNMO to a lower potential cut-off of 3.5 V versus Li/Li⁺. In general, lithiated materials demonstrated a lower first discharge capacity ranging from 102-117 mAh g⁻¹ compared to 124 mAh g⁻¹ for Li_{1.04}NMO. There was not a clear trend between the reversible capacity and the amount of extra lithium, which suggested that the degree of lithiation was not the determining factor. Without wishing to be bound by theory, it is believed that residual contamination in the LLNMO powder not removed by the washing process may detrimentally affect the reversibility. The cycle stability of LNMO and LLNMO were tested at a C/10 rate to determine whether the presence of larger amounts of Mn³⁺ in the lithiated structure during the initial charge had a detrimental effect on capacity retention. The results demonstrated that the discharge capacity was lower for LLNMO, over 40 cycles the stability of LLNMO is comparable with baseline LNMO (FIG. 6).

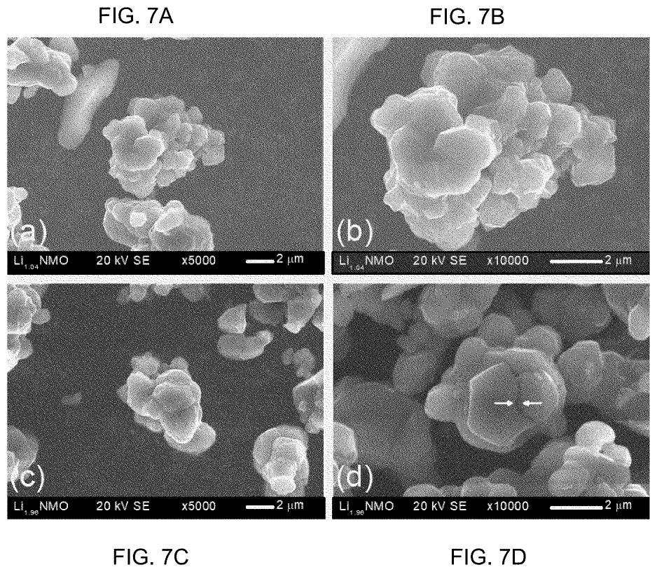

To determine the effect of lithiation on the morphology of the LNMO particles, SEM images were taken before and after lithiation for Li_{1.04}NMO and, for greatest contrast, the most highly lithiated sample, Li_{1.96}NMO (FIG. 7). While the overall particle size, shape and agglomeration remained unchanged, particle cracking was evident in the Li_{1.96}NMO particles (FIG. 7). The high concentration of Jahn-Teller active Mn³⁺ (62% of the total Mn in Li_{1.96}NMO) created structural distortions and strains severe enough to generate cracks in the particles. Without wishing to be bound by theory, it is believed that at lower extents of lithiation the distortion observed would likely be less and therefore would not give rise to particle cracking if the grain boundaries could buffer the anisotropic expansion. The loss of particle contact from cracking may give rise to a lower reversible capacity for LLNMO.

### Example 3

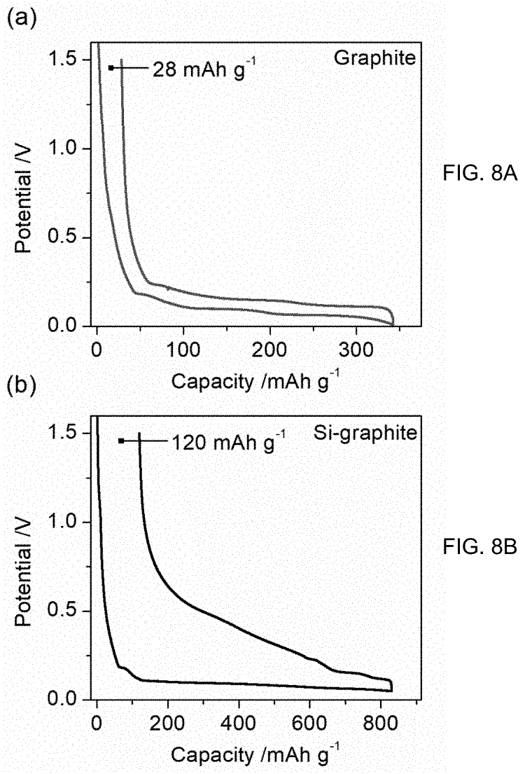

One reason to pre-lithiate cathode active materials is to provide additional lithium to the full cell to compensate for the first cycle irreversible capacity (IC) of the anode. To determine the effectiveness of the ammonia-based chemical lithiation method, two anodes were selected. The first anode selected was graphite, the anode active material found in most commercial LIB, which demonstrated a relatively small first cycle IC (8.3%). A Si-graphite composite electrode was the second anode considered, which demonstrated a larger first cycle IC (14.5%). The IC of the graphite and Si-graphite electrodes were quantified by constructing half-cells and cycling them at C/10 (FIG. 8). Determining the amount of capacity lost during the first cycle allowed for the appropriate matching of each anode with a LLNMO that had an appropriate amount of extra lithiation capacity. In balancing the electrodes in a full cell, care was taken to ensure that the n/p ratio never fell below 1.1. From these considerations, graphite was paired with Li_{1.35}NMO and Si-graphite was paired with Li_{1.62}NMO. For comparison, baseline graphite//Li_{1.04}NMO and Si-graphite//Li_{1.04}NMO cells were also tested under the same conditions.

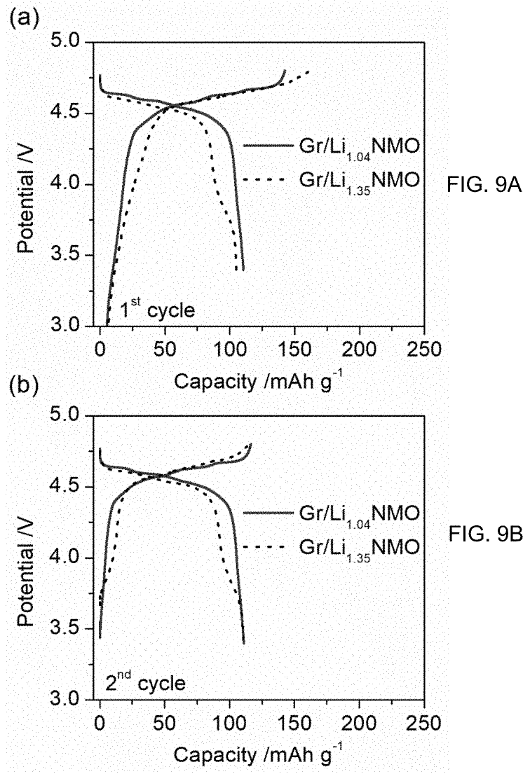

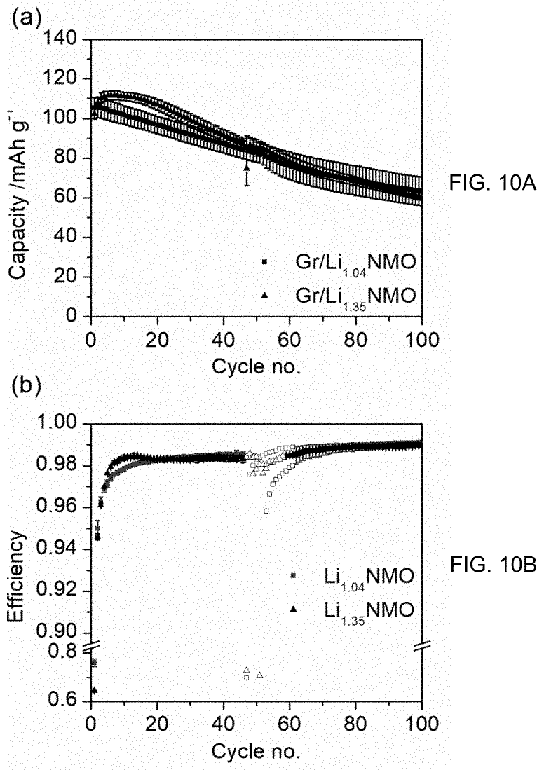

For simplicity in the following discussion, cells will be referred to by their point of difference, namely the cathode lithium content LiₓNMO. Full cell potential profiles for the first and second charge and discharge of LiNi_{0.5}Mn_{1.5}O₄ and chemically lithiated Li_{1.35}Ni_{0.5}Mn_{1.5}O₄ were determined with a graphite anode at a rate of C/10 (FIG. 9). In the first charge, Li_{1.35}NMO delivered 159 mAh g⁻¹_{LNMO} of capacity compared to 139 mAh g⁻¹_{LNMO} for Li_{1.04}NMO, which demonstrated a difference of 20 mAh g⁻¹_{LNMO}. Most of the extra capacity was extracted below 4.5 V. Upon discharge, Li_{1.35}NMO demonstrated a lower discharge capacity (102 mAh g⁻¹_{LNMO}) compared to Li_{1.04}NMO (105 mAh g⁻¹_{LNMO}), however. This was consistent with the half-cell result for Li_{1.35}NMO, which demonstrated a reversible capacity 17 mAh g⁻¹ lower than that of Li_{1.04}NMO (107 mAh g⁻¹ and 124 mAh g⁻¹, respectively). Due to this, both the baseline and over-lithiated cells demonstrated similar discharge capacities in the first few cycles. In contrast, from cycles 5 to 20, Li_{1.35}NMO demonstrated improved capacity retention and high Coulombic efficiency than Li_{1.04}NMO (FIG. 10). Without wishing to be bound by theory, it is believed that this observation was related to the pre-lithiation and the lower reversibility of Li_{1.35}NMO, which combined lead to a reserve of available lithium left on the anode at the end of the first discharge. The reserve of lithium was gradually diminished on a per cycle basis, with the rate of loss related to the extent of active lithium lost from cellular irreversible processes, such as SEI formation/repair. The “knee” present in the potential profile at 3.8 V for Li_{1.35}NMO but absent for Li_{1.04}NMO (FIG. 9) was also evidence for a lithium reserve in the former cells. Beyond 20 cycles, the capacity of Li_{1.35}NMO decreased to the same value as Li_{1.04}NMO and then faded at the same rate. After 100 cycles, the discharge capacity and Coulombic efficiency were equivalent, within the error. The data demonstrate that there are minimal gains by using the LLNMO prepared via chemical pre-lithiation to compensate for the IC of graphite.

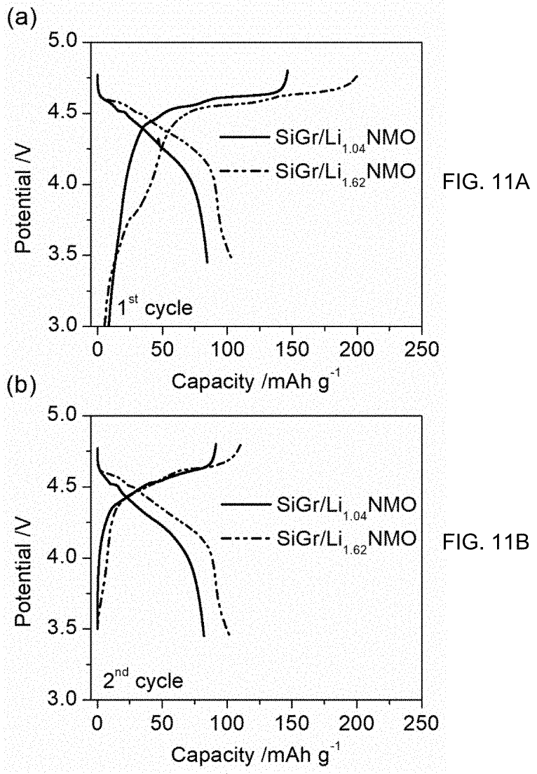

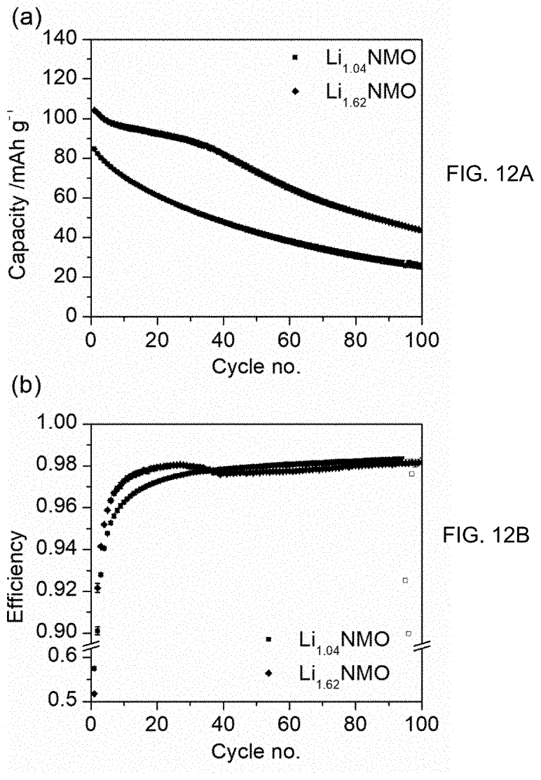

Pre-lithiation becomes more important when the IC of the anode is large. To demonstrate this, full cell potential profiles for the first and second charge and discharge of Li_{1.04}Ni_{0.5}Mn_{1.5}O₄ (Li_{1.04}NMO) and chemically lithiated Li_{1.62}Ni_{0.5}Mn_{1.5}O₄ (Li_{1.62}NMO) were determined with a Si-graphite composite anode at a rate of C/10 (FIG. 11). Due to the larger IC of the Si-graphite composite electrode, the Coulombic efficiency for Li_{1.04}NMO was determined to be 57% (charge and discharge capacity of 147 and 85 mAh g⁻¹_{LNMO}, respectively). In contrast, with chemical pre-lithiation, the first charge capacity of Li_{1.62}NMO was determined to be 201 mAh g⁻¹_{LNMO}, with a reversible capacity of 104 mAh g⁻¹_{LNMO}. The reversible capacity was therefore 19 mAh g⁻¹_{LNMO} higher for the cells where the IC is compensated by the cathode pre-lithiation; a 23% improvement. The increased first discharge capacity carried over into subsequent cycles (FIG. 11), and after 100 cycles at C/10 the cells with Li_{1.62}NMO delivered 44 mAh g⁻¹_{LNMO} of capacity (FIG. 12). This is 18 mAh g⁻¹_{LNMO} higher than the baseline Li_{1.04}NMO case. Additionally, the capacity retention over 100 cycles was higher for Li_{1.62}NMO relative to Li_{1.04}NMO (42% and 30%, respectively).

FIGS. 11 and 12, demonstrate clear signs that the Si-graphite anode in in Li_{1.62}NMO cells had not been fully emptied after the first cycle, as was the case for graphite//Li_{1.35}NMO cells. As a result, a higher Coulombic efficiency and good capacity retention from cycle 2 to 34 was observed for Li_{1.62}NMO compared to that of Li_{1.04}NMO. The anode lithium reserve was apparently exhausted around cycle 34 and the Coulombic efficiency of Li_{1.62}NMO decreased to match that of Li_{1.04}NMO (97.8% at cycle 35), with the capacity fade tracking more closely. For example, between cycles 70 and 100, the capacity fade in cells with and without cathode pre-lithiation was equivalent, at 75% retention over these 30 cycles. The equivalent fade rate noted between cathodes with and without pre-lithiation established that the pre-lithiation has had no detrimental effect on the cycling. However, as demonstrated in both the graphite and Si-graphite systems the rate of fade is substantially higher than desired.

This highlighted two issues that required further attention, the capacity fade attributed to Mn dissolution and the (de)lithiation of silicon during repeated cycling results in large volume expansion and contraction of the particles. The dominant cause for capacity fade in the graphite full cells was found to arise from Mn dissolution, migration, and/or incorporation into the graphite solid electrolyte interphase (SEI). The capacity retention with a Si-graphite anode was lower than with graphite (30% compared to 60%, respectively, over 100 cycles at C/10 against Li_{1.04}NMO), which highlighted the second reason for capacity fade in this study. In addition to Mn dissolution problems, (de)lithiation of silicon during repeated cycling resulted in large volume expansion and contraction of the particles. SEI delamination, reformation, and repair was therefore continuously taking place each cycle, irreversibly and constantly depleting the active, cyclable lithium. Further, the repeated volume changes and increasing quantities of delaminated SEI products caused electrode degradation in the form of cracking, active particle isolation, and electrode densification (loss of porosity).

### Example 4

The electrodes used in this work were supplied by the Cell Analysis Modeling and Prototyping (CAMP) facility at Argonne (Lemont, Ill.). The LiNi_{0.5}Co_{0.2}Mn_{0.3}O₂ (NCM523) positive electrode has a composition of 90 wt. % NCM523 (Toda Advanced Materials, Ontario, Canada), 5 wt. % C-45 conductive carbon, and 5 wt. % polyvinylidene fluoride (PVDF) as the binder. The Si-graphite negative electrode was prepared with a composition of 15 wt. % Si (Paraclete Energy, Chelsea, Mich.), 73 wt. % graphite (Hitachi MAGE), 2 wt. % C-45 carbon, and 10 wt. % lithium polyacrylate (LiPAA) binder. Punched electrodes, 14 mm for the NCM523 cathode and 15 mm for the Si-graphite anode, were dried in a vacuum oven overnight at 75° C. and 150° C., respectively. The loading of the cathode was 10.2(2) mg cm⁻² (1.86(3) mAh cm⁻²) and the anode was 2.8(2) mg cm⁻² (2.80(1) mAh cm⁻²).

Electrochemical measurements were performed in 2032-type coin cells that were assembled in an argon-filled glovebox with oxygen levels less than 1 ppm. Cells were built with 45 μL of electrolyte, which contained 1.2 M LiPF₆ in ethylene carbonate (EC):ethyl methyl carbonate (EMC) 3:7 by weight with 10 wt. % fluoroethylene carbonate (FEC). The Celgard separator was dried at 60° C. under vacuum prior to use. Half-cell measurements used 15.6 mm diameter lithium metal chips (MTI) as the reference/counter electrode. All electrochemical tests were performed at 30° C. using a MACCOR Series 4000 Test System (MACCOR). Half-cells were cycled between 4.5-3.0 V at C/10 for NCM523, and between 1.5-0.1 V at C/10 for Si-graphite. Electrochemical lithiation of NCM523 was conducted in half-cell configuration, where the cathode was discharged to a certain capacity (20, 40, 60, 80 and 100 mAh g⁻¹_{NCM}) or potential (1.1 V) limitation. In the discharged state and in an argon filled glovebox the cell was decrimped. The over-lithiated cathode was then extracted from the cell and immediately rebuilt in a Li₁₊ₓNCMO₂/Si-graphite full cell. Li₁₊ₓNCMO₂/Si-graphite full cell performance was evaluated in a 3.0-4.1 V potential window. The cycling protocol for 100 cycles, consisted of three C/20 formation cycles, 94 C/3 aging cycles, and three C/20 diagnostic cycles. The first and last C/3 cycles applied a hybrid pulse power characterization (HPPC) test on discharge to measure the DC impedance. At pre-determined cell voltages a 3 C, 10 s discharge pulse followed 40 s later by a 2.5 C, 10 s charge pulse was applied; at each voltage the cell was allowed to equilibrate for 1 h prior to the first 10 s pulse.

Ex-situ Ni, Co and Mn K-edge X-ray absorption spectroscopy was performed to detect the change of the TM valence states for pristine and over-lithiated cathodes at beamline 10BM (MRCAT) at the Advanced Photon Source of Argonne National Laboratory. The measurements were carried out in transmission mode with a Ni, Co, or Mn metal foil as a reference, which provides internal calibration for the X-ray energy. Coin cells with NCM523 as the cathode and Li metal as the anode were over-lithiated to 1.1 V using a constant current mode. The cells were decrimped in an argon filled glove box and the cathode extracted. The electrodes were washed in 1 mL DMC to remove excess electrolyte, dried under vacuum at 70° C. and sealed between two pieces of Kapton tape for measurement at the beam line. The XANES spectra were normalized and analyzed using the ATHENA software package (see Ravel, B. and Newville, M. Journal of Synchrotron Radiation 12:537-541 (2005)).

Cells for in situ synchrotron X-ray diffraction (XRD) measurements were constructed using modified 2032 coin cells with 2 or 3 mm diameter holes in the cell casing. NCM523 was used as the cathode and a lithium metal chip as the counter/reference electrode. To maintain stack pressure and conductivity, a thick glassy carbon disk with a thinner window in the center was employed on the cathode side, and the cell was hermetically sealed by an O-ring. On the counter electrode side a thick glassy carbon disk maintained even stack pressure and the cell was sealed with an aluminized Kapton window. The electrochemical protocol for the in situ cells was as follows: discharge at C/8 to a capacity (20, 40, 60, 80 and 100 mAh g⁻¹_{NCM}) or voltage (1.1 V) limitation, charge to 4.5 V, and discharge to 3.0 V. Due to time constraints at the beam line the discharge step did not complete for the larger over-lithiation capacity cells. The high energy synchrotron XRD measurements were carried out at beamline 11-ID-C at the Advanced Photon Source at Argonne National Laboratory (λ=0.1173 Å). Scans were collected in a Debye-Scherrer geometry using an amorphous-Si PerkinElmer 1621 area detector with a 20 s exposure time and 8 min between scans. The data were integrated (0.25-9.25° 2θ, 0.002° 2θ step) using GSAS-II using a CeO₂ standard (SRM674b) as a calibrant. Background subtraction was performed based on the average of multiple scans collected for a cell with the glassy carbon windows, but without electrodes or electrolyte. The 2θ regions that include reflections from Li metal were excluded. Rietveld refinements were carried out using GSAS-II using a structural model based on the R-3m space group. During sequential refinements the refined parameters were the lattice parameters (a and c), scale factor, z position for O²⁻ and an isotropic strain term. Other parameters, such as the atomic displacement parameters and isotropic size were refined initially and then fixed.

NCM523 (Toda) was lithiated chemically using a previously outlined procedure (see Johnson, C. S. et al. Chemistry of Materials 15:2313-2322 (2003)). NCM523 powder was stirred at room temperature for 4 days in a 50% mole excess 0.1 M lithium naphthalide solution that had been freshly prepared from naphthalene (99.6%, Alfa Aesar, Haverhill, Mass.) and metallic lithium (MTI) in tetrahydrofuran (THF; ≥99.9%, Sigma) solvent. The product was filtered and washed in diethyl ether (≥99.9%, Sigma) and stored in an argon glovebox (O₂<1 ppm).

### Example 5

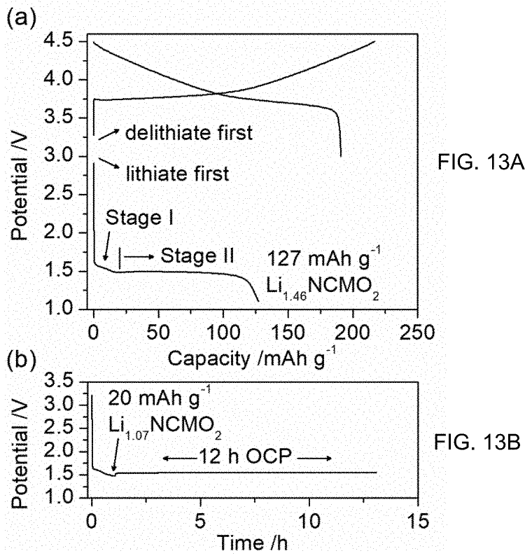

To demonstrate the over-lithiation capacity of Li₁₊ₓNi_{0.5}Co_{0.2}Mn_{0.3}O₂ (Li₁₊ₓNCMO₂), where x is the mole fraction of additional lithium, galvanostatic cycling experiments with a lithium metal counter/reference electrode were performed. Since lithium ion battery (LIB) cathodes are often the lithium source for the cell they are typically charged first, during which lithium is extracted from the layered structure. The potential profile for this process was demonstrated in FIG. 13. In general, as-synthesized layered cathode material with a Li:metal ratio of 1 was considered “full” of lithium. It was also demonstrated that upon discharge, LiNCMO₂ will accept an additional 127 mAh g⁻¹_{NCM} of capacity above 1.1 V versus Li/Li⁺, yielding an over-lithiation composition of Li_{1.46}NCMO₂ (FIG. 13(A)). From an open circuit potential (OCP) of near 3 V, the potential initially dropped rapidly to 1.6 V and a short 20 mAh g⁻¹_{NCM} sloping potential region was observed to 1.5 V. At 1.5 V the potential stabilized, giving a plateau for a further 80 mAh g⁻¹_{NCM}. Beyond this, the potential began to decrease before rapidly polarizing to the 1.1 V potential termination.

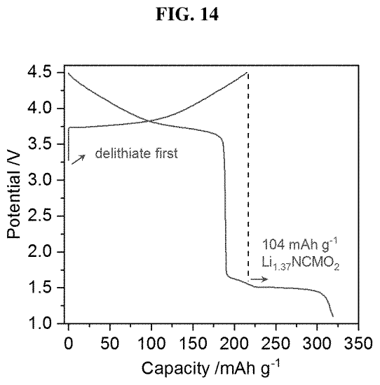

A similar Li₁₊ₓNCMO₂ composition was also realized if the lithiation to 1.1 V was preceded by delithiation of the cathode (FIG. 14). Accessing the short, sloped region between 1.5-1.6 V has been shown to “recover” the irreversible capacity on the first charge-discharge cycle (see Kang, S. H. et al. Electrochimica Acta 54:684-689 (2008), Kang, S. H. et al. J Mater Sci 43:4701-4706 (2008)), lost due to sluggish lithium diffusion kinetics (see Kasnatscheew, J. et al. J Electrochemical Soc 163:A2943-A2950 (2016)). Kang et al. demonstrated that NCM111 cycled with 100% Coulombic efficiency has an end-of-discharge potential of ˜1.5 V that gradually increased to ˜3 V during a 20 h OCP relaxation period. The present technology differs in that over-lithiation was accomplished by discharging first, in all cases adding extra lithium (x>1) to the system. Consequently, after over-lithiation only accessing the 1.6-1.5 V sloped region, 20 mAh g⁻¹_{NCM}, the potential of the cell was 1.5 V and during a 12 h rest the OCP quickly stabilized to 1.55 V (FIG. 13(B)).

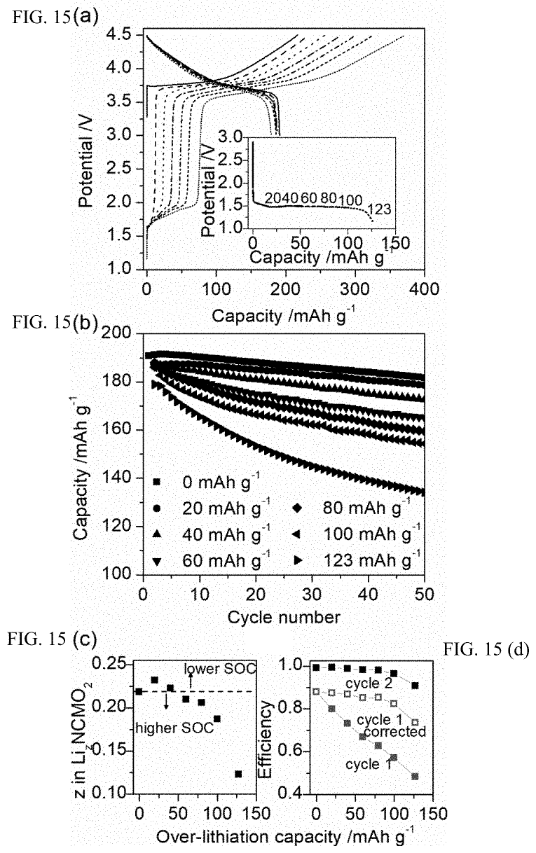

Without wishing to be bound by theory, it is believed that for Li₁₊ₓNCMO₂ to be an ideal pre-lithiation source and cathode, the over-lithiation step should not detrimentally affect the electrochemical performance of the material on subsequent cycles. To determine the impact of over-lithiation on subsequent cycling, cells were first lithiated to various capacity limitations (20, 40, 60, 80, 100 mAh g⁻¹_{NCM} and 1.1 V (123 mAh g⁻¹_{NCM})) and then cycled between 3.0-4.5 V in half-cells. FIG. 15(A) demonstrates that the additional lithium inserted at 1.5 V was extracted between 1.6 and 2.0 V before the cell potential increased to 3.5 V. However, not all of the lithium inserted at 1.5 V was recovered at potentials below 3 V. Rather, irrespective of the over-lithiation capacity, only 61% of the additional lithium was extracted below 3 V, thereby implying significant potential hysteresis during the insertion-removal process.

The discharge capacity was determined over 50 cycles at C/10 between 3.0-4.5 V is shown in FIG. 15(B). When compared to the baseline, no over-lithiation (0 mAh g⁻¹_{NCM}), lower extents of lithiation (20 and 40 mAh g⁻¹_{NCM}) demonstrated a decrease in the delivered capacity, respectively by 3 and 9 mAh g⁻¹_{NCM} after 50 cycles, with similar rates of capacity fade. Conversely, >60 mAh g⁻¹_{NCM} of over-lithiation led to severe capacity fade, particularly over the first 20 cycles. Decreasing the potential below 1.5 V appeared to be particularly damaging to the reversibility of the material, where over-lithiation to 1.1 V (123 mAh g⁻¹_{NCM}) resulted in only 132 mAh g⁻¹_{NCM} on the 50^{th} cycle compared to 153 mAh g⁻¹_{NCM} after over-lithiation to 100 mAh g⁻¹_{NCM} (1.46 V over-lithiation termination).

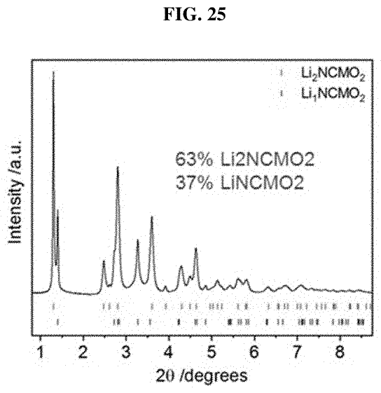

To understand the poor capacity retention after over-lithiation, the cathode state of charge (SOC x in LiₓNCMO₂, where x represents the total lithium content) and the Coulombic efficiency are each plotted as a function of the over-lithiation capacity (FIGS. 15(C) and 15(D)). FIG. 25 illustrates the X-ray diffraction pattern of a chemically over-lithiated Li₁₊ₓNi_{0.5}Co_{0.2}Mn_{0.3}O₂ (labeled as Li₂NCMO₂), and normal layered LiN_{0.5}Co_{0.2}Mn_{0.3}O₂ (labeled as Li₁NCMO₂). The over-lithiated Li₁₊ₓNi_{0.5}Co_{0.2}Mn_{0.3}O₂ was produced by reacting lithium napthalenide in tetrahydrofuran solvent at room temperature, demonstrating a total lithium contenting of approximately 63% in the powder. Over-lithiation to 20 and 40 mAh g⁻¹_{NCM} resulted in similar, or slightly lower, degrees of lithium extraction at the end of the first charge cycle to 4.5 V. Higher degrees of over-lithiation led to a higher SOC at 4.5 V, which led to proportionally less lithium in the layer. It is well established that cycling NCM to higher SOC, typically by cycling to higher voltages, is detrimental to the capacity retention. This is generally attributed to a combination of electrolyte oxidation, structural changes at the surface of the particle, transition metal dissolution, causing an impedance rise on the cathode and a greater loss of active lithium (see Wandt, J. et al. Materials Today 21:825-833 (2018), Faenza, N. V. et al. Langmuir 33:9333-9353 (2017)). The decreased capacity retention is consistent with previous reports, however it does not explain why over-lithiation has led to greater degrees of lithium removal when cycled to the same upper potential termination. In addition, consideration of the Coulombic efficiency for the first and second cycles (FIG. 15(D), corrected in the first cycle by subtracting the over-lithiation capacity from the charge capacity) demonstrated poorer reversibility for higher over-lithiation capacity. In the first cycle NCM523 typically had an efficiency of 87.9%. Over-lithiation between 20 and 80 mAh g⁻¹_{NCM} caused this value to decrease approximately linearly to 85%. Past this point, the reversibility was more severely impacted, with efficiencies of 82% and 73% for 100 and 123 mAh g⁻¹_{NCM} over-lithiation, respectively. A similar trend was evident in the second cycle efficiencies, highlighting an issue with the ongoing reversibility.

### Example 6

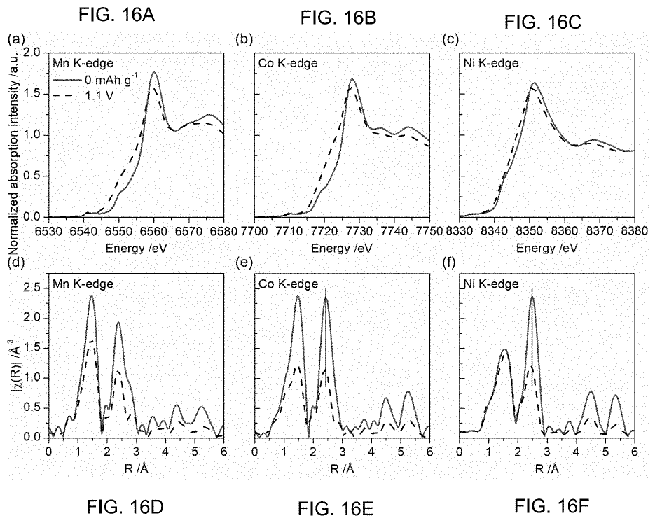

To determine transition metal oxidation state and local structure change after over-lithiation ex situ X-ray absorption spectroscopy (XAS) was employed. Further, in situ X-ray diffraction (XRD) was employed to gain insight into the bulk structural changes during over-lithiation and during the first charge-discharge cycle. X-ray absorption near edge structure (XANES) spectra for the pristine NCM (0 mAh g⁻¹_{NCM} over-lithiation) and after over-lithiation to 1.1 V (123 mAh g⁻¹_{NCM}) at the Mn, Co and Ni K-edge are shown in FIGS. 16(A)-16(C). Extended X-ray absorption fine structure (EXAFS) spectra for the pristine NCM (0 mAh g⁻¹_{NCM} over-lithiation) and after over-lithiation to 1.1 V (123 mAh g⁻¹_{NCM}) at the Mn, Co and Ni K-edge are shown in FIGS. 16(D)-16(F).

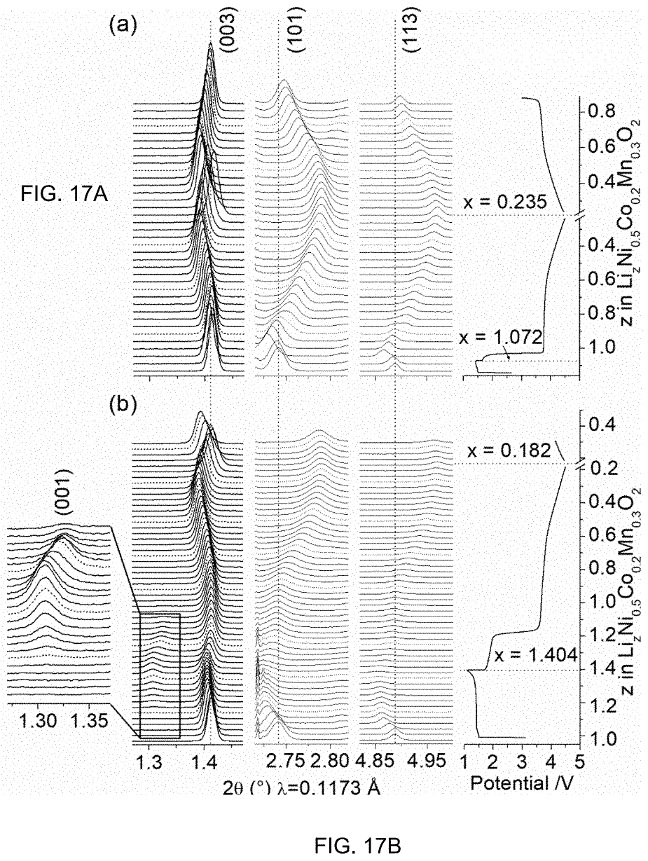

Synchrotron X-ray diffraction (SXRD) scans collected during over-lithiation, delithiation (charge to 4.5 V) and relithiation (discharge to 3.0 V) at a C/8 rate are shown in FIG. 17. Data was collected for all over-lithiation conditions, 20, 40, 60, 80, 100 mAh g⁻¹_{NCM} and to 1.1 V (123 mAh g⁻¹_{NCM}), although due to space considerations only scans from the 20 mAh g⁻¹_{NCM} and 1.1 V cells are shown in FIGS. 17(A) and 17(B), respectively. Select 20 ranges are displayed to highlight the evolution of the 003, 101 and 113 Bragg reflections, indexed based on the rhombohedral crystal system with R-3m space group. The potential profile from the in situ cells is shown adjacent to the scans. Qualitatively, during over-lithiation the 003, 101 and 113 reflections initially demonstrated a subtle shift in position to smaller angles, evident in the first three patterns collected for both 20 mAh g⁻¹_{NCM} and 1.1 V over-lithiation. After this reflection shift, the 20 mAh g⁻¹_{NCM} capacity limitation was reached and the reflections demonstrated a reversible shift back to the starting position as delithiation proceeded. As lithiation continued for the 1.1 V cell, the intensity of reflections from the R-3m phase decreased and a new reflection at 1.31° 2θ (5.14 Å d-spacing) appeared and grew in intensity. This reflection was assigned to the 001 reflection of the P-3m₁ space group, and was previously observed in other over-lithiated layered materials (see Johnson, C. S. et al. Chemistry of Materials 15:2313-2322 (2003), Robert, R. et al. Chemistry of Materials 30:1907-1911 (2018)). At the 1.1 V cut-off, this reflection remained weak, broad and co-existed with R-3m phase reflections, which indicated a disordered P-3m₁ structure in some electrode regions.

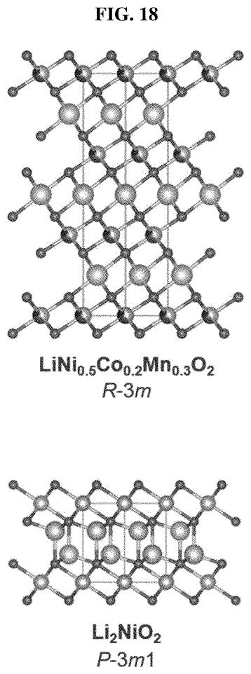

The Li₂MO₂ P-3m₁ phase has hexagonal symmetry in which the oxygen atoms are arranged in a hexagonal close packed array. Similar to the LiMO₂ R-3m phase, metal ions are located in all the octahedral sites of one layer. Lithium ions were accommodated in the adjacent layers; in Li₂MO₂ P-3m₁ the lithium ions occupied all the tetrahedral sites (two rows of lithium ions in the layer), in contrast to LiMO₂ R-3m in which the lithium ions occupied octahedral sites (FIG. 18). FIG. 18 illustrates the expansion of the c-axis in the layered structure for the over-lithiated phase Li₁₊ₓNi_{0.5}Co_{0.2}Mn_{0.3}O₂ material. The interlayer spacing was expanded in the over-lithiated material in two aspects. One is a solid-solution region 1 by around 0.018 Å as the first aspect, and the second aspect with a unique interlayer d-spacing of 2.51 to 2.70 Å. Thus the over-lithiated phase can be seen as a disordered material with lithium in some Td sites and some in octahedral sites in the over-lithiated structure. Two main processes were therefore observed during over-lithiation. Stage I was a short solid-solution region during which additional lithium was accommodated in the Li_{1+δx}MO₂ R-3m phase (where δ×<0.1), which resulted in a reflection shift to smaller angles and without a phase change. This stage accounted for the short 20 mAh g⁻¹_{NCM} sloped potential region observed between 1.6-1.5 V. In stage II, during the longer 1.5 V plateau, a two-phase reaction was evident in the SXRD patterns. Reflections from LiMO₂ R-3m gradually decreased in intensity and a new reflection characteristic of Li₂MO₂ P-3m₁ phase increased.

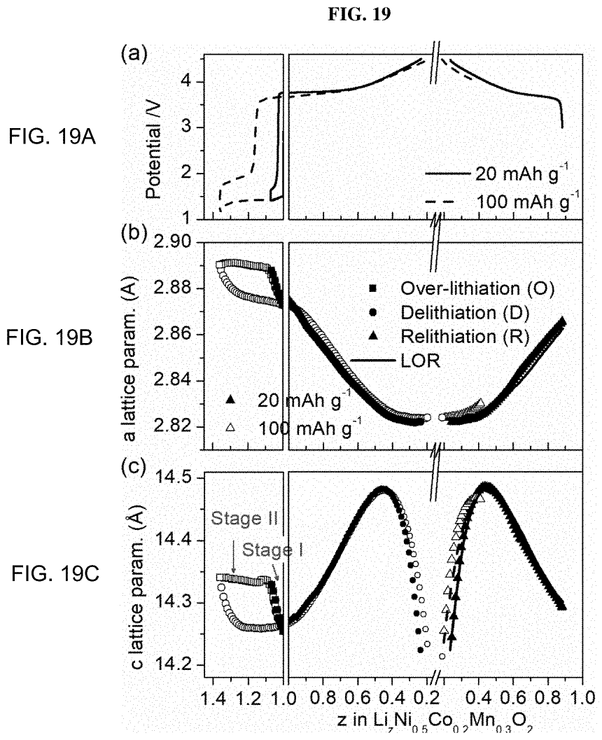

While 20 mAh g⁻¹_{NCM} of over-lithiation demonstrated good structural reversibility for x>1, this did not appear to be the case for over-lithiation to 1.1 V. Examination of FIG. 17(B) demonstrated that in the early stages of delithiation the 001 P-3m₁ reflection and the R-3m reflections first shifted to higher 2θ angles. Concurrently, the P-3m₁ reflection decreased in intensity and the R-3m reflections regained intensity. To better quantify and visualize the structural hysteresis, the a and c lattice parameters for the R-3m phase were determined from Rietveld refinement (FIG. 19). In the region x>1, the structural hysteresis loop was clear for both the a and c lattice parameters. Consistent with previous observations, for 20 mAh g⁻¹_{NCM} over-lithiation there was no structural hysteresis. The a and c lattice parameters increased and then decreased along the same path, where a increased from 2.8730(1) Å to 2.8879(2) Å, and c increased from 14.2541(5) Å to 14.3288(6) Å, respectively. Increasing the over-lithiation capacity to 40 mAh g⁻¹_{NCM} or higher, and thus entering the two-phase transition in stage II, demonstrated a hysteresis loop at x>1 for over-lithiation and delithiation. The early stages of delithiation demonstrated a rapid decrease in the a and c lattice parameters, similar to the increase seen in the early stages of over-lithiation. Without wishing to be bound by theory, it is believed that this indicated that delithiation proceeded by first extracting the lithium inserted during stage I, followed by extracting the lithium inserted via the two-phase reaction in stage II. Clearly, there was a significant over-potential associated with extracting lithium from the Li₂MO₂ P-3m₁ phase. This was consistent with the hysteresis noted earlier in the potential profile, with 39% of the over-lithiation capacity extracted at potentials over 3.0 V.

As the structure returned to the starting composition, nominally x=1, the a and c lattice parameters returned close to their original values. The a lattice parameter returned within ±0.002 Å of the original 2.8735(1) Å value. Meanwhile c was, on average, 14.2660(8) Å; 0.010(1) Å higher after over-lithiation relative to the 14.2559(5) Å starting value, with no clear trend with degree of over-lithiation. This implied that the bulk average inter-layer spacing was wider after any amount of over-lithiation. Without wishing to be bound by theory, it is believed that given the strong correlation between the c-lattice parameter and the lithium ion diffusion kinetics (see Kang, K., Ceder, G. Phys. Rev. B 74:94-105 (2006); Kang, K. et al. Science 311:977-980 (2006)), the increase in the inter-layer distance may improve lithium extraction kinetics at and around x=1 and contribute in part to the greater degree of delithiation after over-lithiation. On continued delithiation below x=1 the a and c lattice parameters evolved in a similar fashion to that expected for NCM materials. The a lattice parameter decreased approximately linearly to ˜2.823 Å before steadying around x=0.35. Meanwhile, c increased to a maximum of ˜14.48 Å at x=0.45 (4.07 V), before it quickly decreased to ˜14.22 Å at 4.5 V. Comparing the effect of over-lithiation more closely, between x=1 and x=0.5 the a and c lattice parameters tracked very closely. However, at the c lattice maximum, x=0.45, cells with high over-lithiation (1.1 V, 123 mAh g⁻¹_{NCM}) exhibited 0.009(2) Å less lattice expansion compared to over-lithiation to 20 and 40 mAh g⁻¹_{NCM}. From x=0.45 to the charged state (where x depends on the over-lithiation capacity) the lattice evolution differed more markedly. The c lattice parameter dropped more rapidly after 20 and 40 mAh g⁻¹_{NCM} over-lithiation compared to that after 100 and 123 mAh g⁻¹_{NCM} over-lithiation. Therefore, at a given SOC for x<0.35, the c lattice parameter was larger for materials that have experienced a higher over-lithiation capacity. In fact, the difference was quite conspicuous, for example, at x=0.236 the cell with 20 mAh g⁻¹_{NCM} over-lithiation was at 4.5 V and the c lattice parameter was 14.2237(8) Å. Linear regression was used to determine the c lattice parameter for the other data sets at this same x value. After lithiation to 100 and 123 mAh g⁻¹_{NCM}, the c lattice parameter at x=0.236 was 14.3150(12) Å, which was 0.091(2) Å larger. The larger c lattice parameter, and hence the larger inter-layer distance, for x<0.35 (representing 17% of the charge time >3.5 V) likely resulted in a greater proportion of lithium removal from the structure before the 4.5 V cut-off. It implied a structural memory effect from the over-lithiation, where the inter-slab distance was increased and held in the expanded state for a time dependence on the over-lithiation capacity.

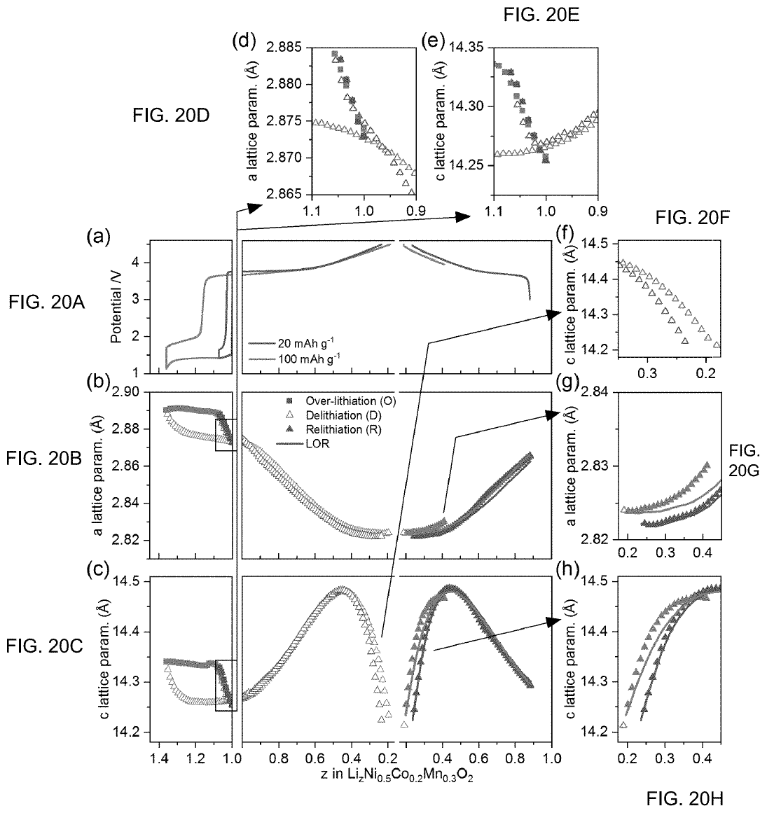

The structural reversibility was determined by comparing the a and c lattice parameter evolution on charge (delithiation) and discharge (relithiation). FIG. 19 indicates the pathway for zero hysteresis (de)lithiation reversibility with a solid line, labelled the line of reversibility (LOR). Due to time constrains at the beam line, relithiation was not completed for all cells; however there were apparent differences in the data across the SOC measured. Firstly, after low capacity over-lithiation, 20 and 40 mAh g⁻¹_{NCM}, structural data for full relithiation to 3.0 V was obtained. The lattice parameters followed essentially the same path as during delithiation. This implied over-lithiation to these capacities did not affect the structural reversibility on the first cycle in a typical potential window (3.0-4.5 V). This was consistent with the potential profile after over-lithiation to these capacities, which demonstrated minimal overpotential (FIG. 20). Conversely, the potential profiles after high over-lithiation demonstrated a comparatively greater SOC dependent voltage hysteresis for x<1 (FIG. 20). Such hysteresis was also reflected in the structural evolution in FIGS. 19(B) and 19(C), which demonstrated that the a and c lattice parameters increased more rapidly on relithiation than compared to delithiation. Consequently, for 100 mAh g⁻¹_{NCM} over-lithiation the c lattice parameter reached its maximum value on relithiation at x=0.38, compared to x=0.44 on delithiation. The structural evolution appeared to track closely with the voltage rather than with the SOC, since plotting the changes in the a and c lattice parameters with respect to voltage (rather than x) exhibited more similar trends for x<1 after low and high over-lithiation (FIG. 20). The voltage hysteresis and voltage dependent structural evolution, taken together, demonstrated that the charge extracted at high SOC after over-lithiation was not recovered on discharge. FIG. 20(A) also demonstrated that it was also evident that further capacity was lost nearing the discharge state after higher over-lithiation, indicated by a higher overpotential that led to a lower discharge capacity.

Over-lithiation (x>1) and relithiation to x=1 exhibited severe structural hysteresis, with a slight opening of the inter-layer distance after the process returns the lithium content to x=1. After high degrees of over-lithiation the c lattice parameter decreased on delithiation for x<0.35 (above 4.2 V) was slowed, leaving a larger inter-layer spacing at higher SOC. This facilitated faster lithium ion diffusion kinetics and hence a greater degree of lithium removal. The high capacity over-lithiation and the higher SOC reached at 4.5 V disrupted the layered crystal structure, which resulted in structural inhomogeneity and inactive domains. This caused the poor structural and electrochemical reversibility observed after high capacity over-lithiation. Lower over-lithiation capacities led to less severe reversibility issues, particularly when only the stage I solid-solution capacity (<20 mAh g⁻¹_{NCM}) was accessed.

### Example 7

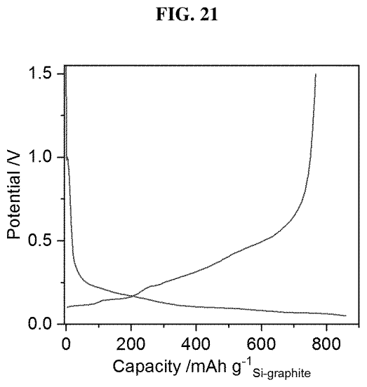

To determine the amount of over-lithiation capacity needed to compensate for the irreversible capacity of an anode, a full cell was built with a Si-graphite composite electrode consisting of 15 wt. % silicon and 73 wt. % graphite used as the anode. It was determined that the addition of 15 wt. % silicon to the electrode more than doubled the capacity over that of graphite alone, while the inclusion of graphite was intended to buffer the large volume changes of the silicon and provide better electrode conductivity and stability than silicon alone. Representative half cell cycling data for this electrode revealed a first cycle lithiation capacity of 846 mAh g⁻¹_{Si-graphite}, reversible capacity of 755 mAh g⁻¹_{Si-graphite} and Coulombic efficiency of 89.3% when cycled at C/10 between 0.05-1.5 V (averages of four cells are quoted; FIG. 21).

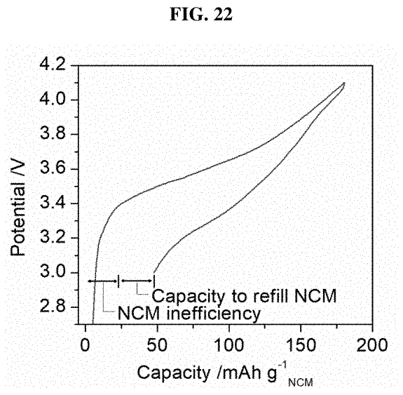

In a full cell, the lithium irreversibly consumed by the anode (SEI formation) on the first cycle reduced the amount of cyclable lithium. After discharge, the cathode had available sites for lithium that were not utilized. To determine the additional capacity required to refill the cathode (accounting for the irreversible capacity of NCM) a representative first charge-discharge cycle of a NCM/Si-graphite full cell was considered in FIG. 22. On charge, the capacity was 180.2 mAh g⁻¹_{NCM}, or 1.86 mAh cm⁻² (average of four cells), and the reversible discharge capacity was 134.1 mAh g⁻¹_{NCM}, or 1.39 mAh cm⁻². Since NCM had a first cycle efficiency of 87.2% (three cell average measured in half cells) the acceptable capacity to refill all the available sites on NCM was 157.2 mAh g⁻¹_{NCM} (180.2 mAh g⁻¹_{NCM}×0.872). Therefore, the amount of capacity required to account for the first cycle irreversible capacity due to lithium loss was 23.1 mAh g⁻¹_{NCM} (157.2-134.1 mAh g⁻¹_{NCM}) for this Si-graphite electrode. Over-lithiation of NCM to 23 mAh g⁻¹_{NCM} was only marginally greater than the 20 mAh g⁻¹_{NCM} limit used in the half cell and in situ XRD experiments described above, which exhibited good capacity retention and structural reversibility. Two other over-lithiation amounts were examined as part of this study. The highest amount was designed to completely lithiate the anode, without lithium plating. This condition had the advantage of adding maximum lithium inventory to the cell, however, this was somewhat offset by the decreased capacity retention due to higher NCM over-lithiation. Given the severity of the lithium loss for the silicon electrode, we anticipate that the silicon electrode will consume lithium at a faster rate than the over-lithiated NCM will lose available sites. Therefore, capacity fade will be a function of the rate of lithium loss and the degradation of the active particles and the Si-graphite electrode. A third over-lithiation condition, between 23 mAh g⁻¹_{NCM} and 70 mAh g⁻¹_{NCM}, of 46 mAh g⁻¹_{NCM} was also examined. Details of the NCM cathode and Si-graphite anode mass loading, capacity and full cell n/p ratio for the various over-lithiation conditions are given in Table 2.

TABLE 2
Electrode properties of Li₁₊ₓNi_{0.5}Co_{0.2}Mn_{0.3}O₂ cathodes and Si-graphite anode
used in full cells. Practical capacities for the LiNi_{0.5}Co_{0.2}Mn_{0.3}O₂ and Si-graphite
electrodes were taken as 180 mAh g⁻¹_{NCM} and 1024 mAh g⁻¹_{Si-graphite} and
were used to calculate the electrode areal capacities. The numbers in the
brackets represent the deviation between the electrodes employed in this work.

| Over- | | | | | | |
|---|---|---|---|---|---|---|
| lithiation | | | | | | |
| capacity | x in | Li₁₊ₓNCMO₂ cathode | | Si-graphite anode | | |
| mAh g⁻¹ | Li₁₊ₓNCMO₂ | mg cm⁻² | mAh cm⁻² | mg cm⁻² | mAh cm⁻² | n/p |
| 0 | 0 | 10.2 (2) | 1.86 (3) | 2.8 (2) | 2.80 (1) | 1.51 (3) |
| 23 | 0.08 | | 2.19 (1) | | | 1.34 (3) |
| 46 | 0.17 | | 2.43 (1) | | | 1.20 (2) |
| 70 | 0.25 | | 2.67 (2) | | | 1.09 (2) |

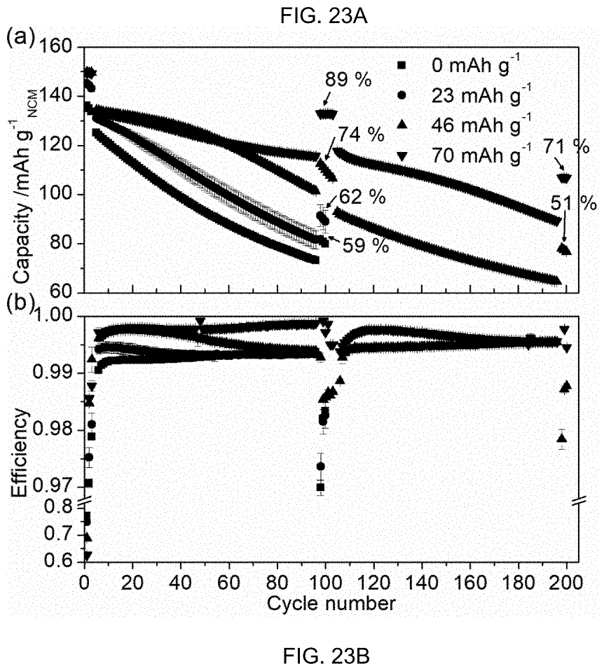

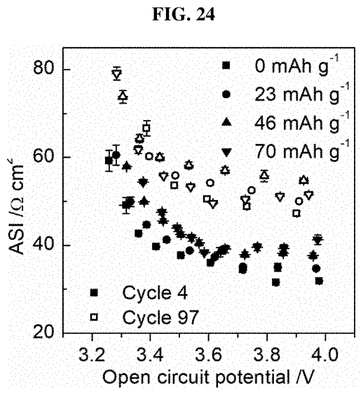

The process of preparing the over-lithiated NCM electrodes was given in detail in Example 4. In brief, NCM electrodes were lithiated to the determined over-lithiation capacity by constructing half cells and discharging to a capacity limitation. Upon completion, the cells were deconstructed, the cathode extracted and paired versus a Si-graphite anode in a full cell. The discharge capacity, Coulombic efficiency and area specific impedance (ASI) results were determined from full cell cycling for the baseline (no over-lithiation) and three over-lithiation conditions (23, 46, and 70 mAh g⁻¹_{NCM}; FIGS. 23 and 24, Table 3). Cycling was conducted at C/20 for three formation cycles, followed by an initial hybrid pulse power characterization (HPPC) cycle, 92 aging cycles at C/3, a final HPPC cycle, and finally three C/20 diagnostic cycles (see Example 4 for further details on the cycling protocol). Without over-lithiation of the cathode, the first discharge capacity at C/20 was 136.1 mAh g⁻¹_{NCM}. The capacity faded rapidly over 100 cycles, with 59% capacity retention after 100 cycles. The Coulombic efficiency was 97.9% in the third cycle at C/20, and slowly increased from 99.1% to 99.4% during the C/3 aging cycles, and was 98.3% on cycle 100 at C/20. Without wishing to be bound by theory, it is believed that the slow improvement may in part be due to formation of a more robust SEI, but may also be related to the decreased capacity.

TABLE 3
Area specific impedance (ASI) data from HPPC cycles at ~3.6 V.
Errors represent the variation between two cells.

| Over-lithiation | ASI at ~3.6 V | | |
|---|---|---|---|
| capacity | Ω cm² | | Δ ASI |
| mAh g⁻¹ | Cycle 4 | Cycle 97 | Ω cm² |
| 0 | 36.0(2) | 50.5(4) | 14.5(6) |
| 23 | 37.2(4) | 54.2(4) | 17.0(8) |
| 46 | 38(1) | 57.1(7) | 19(2) |
| 70 | 39.1(8) | 49.6(3) | 10(1) |

Over-lithiation of the cathode had clearly led to an improvement in the capacity and in some cases the capacity retention (FIG. 23). By compensating only for the first cycle irreversible capacity from lithium loss (23 mAh g⁻¹_{NCM}) the initial discharge capacity (145.2 mAh g⁻¹_{NCM}) was 9.1 mAh g⁻¹_{NCM} higher than without over-lithiation. The Coulombic efficiency was slightly higher than the baseline across the first 40 cycles, although within the final 60 cycles it is equivalent to the cell without over-lithiation. After 100 cycles, the capacity increase over the baseline remained as it was initially at 9.1 mAh g⁻¹_{NCM} (89.0 mAh g⁻¹_{NCM}), with only a slight improvement to the capacity retention. The improvement for 46 and 70 mAh g⁻¹_{NCM} over-lithiation capacity was more pronounced due to the higher lithium inventory initially provided to the cell. In both of these cases, all the lithium on the cathode was delivered to the anode during the first charge cycle. On discharge, the cathode filled before the anode relinquished all the electrochemically available lithium, thereby leaving a reserve of lithium on the anode. This lithium can be released in subsequent cycles to compensate for the irreversible capacity occurring on each cycle. Since the capacity losses were lower after the first cycle, it takes many cycles for the lithium reserve to be exhausted. The rate of capacity fade and the Coulombic efficiency were good indicators for when the lithium reserve is exhausted. After over-lithiation to 46 mAh g⁻¹_{NCM} the capacity began to fade faster and the Coulombic efficiency began to decrease from about cycle 40, which indicated that the lithium reserve was nearly expended. This did not occur after over-lithiation to 70 mAh g⁻¹_{NCM} until approximately cycle 130. Consequently, the capacity retention after 100 cycles after over-lithiation to 46 and 70 mAh g⁻¹_{NCM} was 74% and 89%, respectively, a vast improvement upon the baseline case (59%).

When a lithium reserve was present the Coulombic efficiency increased quickly to 99.8%, and remained above 99.6% in the C/3 aging cycles. On cycle 100, the efficiency at C/20 was 99.5% for the 70 mAh g⁻¹_{NCM} over-lithiated cells. It is important to note that after the lithium reserve was exhausted the Coulombic efficiency decreased to a value consistent with the baseline, no over-lithiation, condition. This implied that the inefficiencies of the Si-graphite electrode return to baseline levels irrespective of whether the lithium reserve was consumed after 1, 40 or 130 cycles. Without wishing to be bound by theory, it is believed that there may be an amount of lithium inventory that can be added to the cell to “break-in” a Si-containing electrode, after which it will cycle with satisfactorily low irreversibility.

A primary concern with using Li₁₊ₓNCMO₂ as a lithium source and a cathode is that the structural and morphological changes induced as a result over-lithiation may adversely affect the impedance. To determine the effect on the impedance, the ASI on cycles 4 and 97 was plotted as a function of the open circuit potential for baseline NCM (no over-lithiation) and after over-lithiation to varying degrees (FIG. 24). In general, the initial impedance after over-lithiation was higher than the baseline case. To illustrate, without over-lithiation the ASI at 3.6 V was 36.0 Ωcm², while after over-lithiation the ASI values were 37.2, 38.4, and 39.1 Ωcm² for 23, 46 and 70 mAh g⁻¹_{NCM} over-lithiation capacity, respectively. The increase in impedance at 3.6 V between cycles 4 and 97 demonstrated an increase in all cases, ranging between 10.5-18.7 Ωcm², however there was no clear trend that a higher over-lithiation capacity led to more impedance rise. Therefore, while the over-lithiation process affects the impedance, the benefit of increasing the lithium inventory in the cell, leading to higher capacity and better retention, outweighed the relatively minor increase in the impedance.

Replacing the cathode after 100 cycles reinstated a full lithium inventory to the cell, and thus the ongoing performance of the cathode was examined while maintaining reasonably high capacities (FIG. 23). The immediate increase in discharge capacity indicated that the loss of capacity over the first 100 cycles was dominated by the loss of lithium at the anode. A higher discharge capacity was achieved in anode cycle 101 (replacement cathode cycle 1) compared to anode cycle 1 since the irreversible capacity of a formed Si-graphite electrode was substantially lower than in the first cycle. The Coulombic efficiency after 200 cycles of the anode (98.3% at C/20) was the same as that after 100 cycles, which indicated no (or imperceptivity slow) improvement to the reversibility. Further, the capacity loss per cycle at C/3 was comparable (0.526(8) mAh g⁻¹_{NCM} per cycle in anode cycles 5-96, and 0.505(1) mAh g⁻¹_{NCM} per cycle in anode cycles 105-196), which further demonstrated that the Si-graphite electrode performance (irreversible lithium loss, silicon particle and electrode degradation) did not improve. Comparing the rate of capacity loss with and without a lithium reserve allowed differentiation of the capacity loss due to irreversible lithium loss versus that due to Si-graphite particle and electrode degradation. When a lithium reserve was present, as was the case for the first 100 cycles after 70 mAh g⁻¹_{NCM} over-lithiation, the available lithium on the anode replaced that consumed in anode SEI formation reactions on each cycle. Without wishing to be bound by theory, it is believed that any loss of capacity was not due to a lack of available lithium, but rather from adverse changes to the Si-graphite electrode prohibiting the capacity from the cycle before from being achieved. The capacity lost per cycle when a lithium reserve was present is 0.238(2) mAh g⁻¹_{NCM}, equating to the Si-graphite anode losing 0.77(1) mAh g⁻¹_{Si-graphite} per cycle. Therefore, at a C/3 rate around 55% of the capacity loss per cycle in the first 100 anode cycles was attributable to lithium loss, while 45% was from particle and electrode degradation. In the next 100 cycles, the situation was only marginally improved, with 53% of capacity lost per cycle arising from lithium loss. As an aside, the deterioration of the Si-graphite electrode (0.238(2) mAh g⁻¹_{NCM} or 0.77(1) mAh g⁻¹_{Si-graphite} per cycle) did not lead to an n/p ratio less than one after the cathode was replaced after 100 cycles. The details for this calculation are listed in Table 4.

TABLE 4
Discharge capacity of cathodes extracted from Li₁₊ₓNCMO₂/Si-graphite full cells after
100 or 200 cycles and rebuilt versus a lithium metal counter/reference electrode. Cycling was
performed at a C/10 rate in the range 3.0-4.3 V. The number of cycles performed in the full cell
before extraction is indicated in the first column. Capacity retention was determined by
comparing the capacity of the cycled cathode to the discharge capacity of a fresh LiNCMO₂
cathode (i.e., 0 cycles in a full cell and 0 mAh g⁻¹_{NCM} over-lithiation) cycled versus
lithium metal under the same conditions.

| | Over-lithiation | Discharge | Capacity |
|---|---|---|---|
| No. of | capacity | capacity | retention |
| cycles | mAh g⁻¹ | mAh g⁻¹ | % |
| 0 | 0 | 166.6 | 100 |
| 100 | 0 | 162.4 | 97.5 |
| | 23 | 157.2 | 94.4 |
| 200 | 46 | 152.5 | 91.5 |
| | 70 | 150.4 | 90.3 |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process for preparing a chemically over-lithiated cathode active material, the process comprising:
contacting lithium-ammonia or lithium naphthalenide with a lithium metal oxide cathode active material to form the chemically over-lithiated cathode active material.

2. The process of claim 1, wherein the chemically over-lithiated cathode active material comprises a first lithium metal oxide phase and a second lithium metal oxide phase that is different from the first lithium metal oxide phase.

3. The process of claim 1, comprising contacting the lithium-ammonia with the lithium metal oxide cathode active material.

4. The process of claim 1, comprising contacting the lithium naphthalenide with the lithium metal oxide cathode active material.

5. The process of claim 1, wherein the lithium metal oxide cathode active material comprises a compound of formula Li_{δ}(M¹_{y}Mn_{2-y})Oₚ, Li_{δ}(M²_{y})Oₚ, Li_{δ}(M²_{y}M³_{2-y})Oₚ, or Li_{δ}(M¹_{y}, R¹ₐ)O_{p′};
wherein:
M¹ is Cr, Fe, Co, Ni, Cu, or a mixture of any two or more thereof;
M² is Fe, Co, Ni, Mn, Ti, V, or a mixture of any two or more thereof;
M³ is different from M² and is Fe, Co, Ni, Mn, Ti, V, or a mixture of any two or more thereof;
R¹ is O, OH, F, Cl, Br, S or I;
0<y<2;
1≤y′≤3;
0<p≤4;
0<p′≤8;
0<δ≤2; and
0≤a≤1.

6. The process of claim 1, wherein the lithium metal oxide cathode active material comprises LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof.

7. The process of claim 1, wherein the lithium metal oxide cathode active material comprises LiMn₂O₄, LiNi_{0.5}Mn_{1.5}O₄, or LiNi_{0.5}Mn_{0.3}Co_{0.2}O₄.

8. The process of claim 2, wherein the first lithium metal oxide phase comprises LiNiₘMnₙCoₒOₚ; and
wherein:
0≤m<1;
0≤n<1;
0≤o<1;
0.5≤p≤4; and
m+n+o=1.

9. The process of claim 2, wherein the first lithium metal oxide phase comprises LiNi_{0.5}Co_{0.2}Mn_{0.3}O₂; and the second lithium metal oxide phase comprises Li_{δ}Ni_{m′}Mn_{n′}Co_{o′}O_{p′};
wherein:
1<δ≤2;
0≤m′<1;
0≤n′<1;
0≤o′<1;
0.5≤p′≤4; and
m′+n′+o′=1.

10. The process of claim 9, wherein the second lithium metal oxide phase comprises Li_{δ}Ni_{0.5}Co_{0.2}Mn_{0.3}O₂, wherein 1<δ≤2.

11. A process for preparing an electrochemically over-lithiated cathode active material, the process comprising:
cycling a half cell comprising a lithium metal oxide cathode active material and a lithium metal counter electrode to form the chemically over-lithiated cathode active material.

12. The process of claim 11, wherein the electrochemically over-lithiated cathode active material comprises a first lithium metal oxide phase and a second lithium metal oxide phase that is different from the first lithium metal oxide phase.

13. The process of claim 11, wherein the lithium metal oxide cathode active material comprises a compound of formula Li_{δ}(M¹_{y}Mn_{2-y})Oₚ, Li_{δ}(M²_{y})Oₚ, Li_{δ}(M²_{y}M³_{2-y})Oₚ, or Li_{δ}(M¹_{y′}R¹ₐ)O_{p′};
wherein:
M¹ is Cr, Fe, Co, Ni, Cu, or a mixture of any two or more thereof;
M² is Fe, Co, Ni, Mn, Ti, V, or a mixture of any two or more thereof;
M³ is different from M² and is Fe, Co, Ni, Mn, Ti, V, or a mixture of any two or more thereof;
R¹ is O, OH, F, Cl, Br, S or I;
0<y<2;
1≤y′≤3;
0<p≤4;
0<p′≤8;
0<δ≤2; and
0≤a≤1.

14. The process of any one of claim 11, wherein the lithium metal oxide cathode active material comprises LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiMn₂O₄, LiNi_{0.5}Mn_{1.5}O₄, LiNi_{0.5}Mn_{0.3}Co_{0.2}O₄, LiV₂O₅, LiV₃O₈, or a combination of any two or more thereof.

15. The process of any one of claim 11, wherein the lithium metal oxide cathode active material comprises LiMn₂O₄, LiNi_{0.5}Mn_{1.5}O₄, or LiNi_{0.5}Mn_{0.3}Co_{0.2}O₄.

16. The process of claim 12, wherein the first lithium metal oxide phase comprises LiNi_{m′}Mn_{n′}Co_{o′}O_{p′}; and
wherein:
0≤m′<1;
0≤n′<1;
0≤o′<1;
0.5≤p′≤4; and
m′+n′+o′=1.

17. The process of claim 16, wherein the first lithium metal oxide phase comprises LiNi_{0.5}Co_{0.2}Mn_{0.3}O₂.

18. The process of claim 12, wherein the second lithium metal oxide phase comprises Li_{δ}Ni_{m′}Mn_{n′}Co_{o′}O_{p′}; and
wherein:
1<δ≤2;
0≤m′<1;
0≤n′<1;
0≤o′<1;
0.5≤p′≤4; and
m′+n′+o′=1.

19. The process of claim 18, wherein the second lithium metal oxide phase comprises Li_{δ}Ni_{0.5}Co_{0.2}Mn_{0.3}O₂, wherein 1<δ≤2.

20. A chemically over-lithiated cathode active material, comprising:
a first lithium metal oxide phase of formula LiMetOₚ; and
a second lithium metal oxide phase of formula Li_{δ}MetOₚ;
wherein:
Met is a transition metal or a mixture of transition metals;
1<δ≤2; and
0.5≤p≤8.
